(19) United States
(12) Patent Application Publication
(10) Pub. No.: US 2017/0193618 A1
(43) Pub. Date: Jul. 6, 2017

(54) Computerised system and Method for Establishing and Trading Contractual Rights in a Creative Production

(71) Applicant: PIIP HOLDINGS PTY LTD, Surry Hills (AU)

(72) Inventor: Klaudiusz Zbygniew Drulik, Surry Hills (AU)

(21) Appl. No.: 15/510,581

(22) PCT Filed: Sep. 14, 2015
(86) PCT No.: PCT/AU2015/000567

§ 371 Date: Mar. 10, 2017

(30) Foreign Application Priority Data
Sep. 12, 2014 (AU) 2014903651
Sep. 12, 2014 (NZ) 631653

(51) Int. Cl. G06Q 50/18; G06Q 40/04; G06F 3/0484

(52) U.S. Cl. CPC G06Q 50/18; G06F 3/04842; G06Q 40/04; G06Q 30/08

(57) ABSTRACT

A method, server processing system, and system for facilitating transfer of rights, as embodied in contracts, with respect to a portion or attribute of a proposed creative production work is disclosed. In one aspect, the server processing system is configured to: receive, from a first processing system operated by a rights holder, first data indicative of a depiction of a proposed creative production work and a selection of one or more portions of the work, wherein rights associated with the selected one or more portions of the work, as embodied in contracts, are available for sale; store the first data in a database; receive, from a second processing system operated by a bidding party, search data indicative of a search query to identify rights to one or more portions of one or more works available for sale; conduct a search of the database based on the search query; transfer search results to the bidding party via the second processing system; receive a bid to purchase the rights associated with at least some of the one or more portions of a proposed creative production; transfer the bid to the rights holder, via the first processing system; receive, from the first processing system, an acceptance of the bid by a rights holder; and store, in the database, transferred rights data indicative of the transfer of rights of the respective one or more portions of the work from the rights holder to the bidding party, wherein the bidding party can control the presentation or broadcast of the respective one or more portions of the work when created in accordance with the rights purchased.

### CROSS-REFERENCE TO RELATED APPLICATIONS

This application is a U.S. national stage application of international application PCTAU2015/000567, filed 14 Sep. 2015, and claims priority under 35 U.S.C. §119 from Australian Provisional Patent Application No 2014903651 filed 12 Sep. 2014 and New Zealand Patent Application 631653 filed on 12 Sep. 2014, the contents of each of which is incorporated herein by reference, in its entirety and for all purposes.

### TECHNICAL FIELD

The present disclosure relates to a computer implemented method and system for establishing and trading contractual rights in a creative production.

The disclosed embodiments may find particular application, for example, in the creation and distribution of creative productions, such as a moving visual work (e.g. video, film, television show, event broadcast, etc.), electronically published work (e.g. software, computer-simulated life, computer-aided design, online magazine, website, video game, etc.), printed work (e.g. magazine, newspaper, etc.) or audio work (e.g. music, etc.).

### BACKGROUND

Moving visual media (e.g. video, film, event broadcast, television show, etc.) accounts for a growing portion of traffic delivered via the Internet. Such media is also becoming indispensable to the marketing, promotion and advertising of products and services. Raising finance for a creative production project, such as a film project, is a complex process. Current financial markets that service creative production projects are relatively unsophisticated compared to mature financial markets that service corporations and corporate projects, like infrastructure and industrial projects. Subsequently, many viable creative production projects fail to secure the necessary finance, leaving them unrealised. This imposes a deadweight loss on society such as reduced cultural diversity, stymied industry growth and weak employment demand in related industries.

It is desirable for those seeking to produce a creative production, such as a film, to have a more efficient system to raise finance, preferably early in the production process at concept stage prior to any creative production being realised and fixed in a medium. Similarly, it is desirable for those seeking to commercialise intellectual property, goods and services by exploiting such work, or those seeking to broadcast, distribute or exhibit such work to an audience via telecommunication, to have a more efficient system to search, find and buy rights related to such work, ideally also at concept stage prior to the realisation of a creative production.

Copyright in a creative production results in exploitable intellectual property comprised of legal rights. Each right may be related to an attribute of the production. One or more authors can determine each attribute of a creative production before it is fixed in a medium while it is still a proposed creative production, portrayed by a previsualisation like a storyboard, script, model, etc. Another way to determine each attribute is to effect a contract between the authors and a stakeholder such that a decision about an attribute is delegated to the stakeholder according to terms, in exchange for consideration. Once the attribute is determined in accordance to the contract, the proposed creative production can be realised as a creative production. Deciding attributes in this way is a technical problem.

### SUMMARY

Embodiments seek to ameliorate the deficiencies of the present state of art, as it relates to the practices of establishing and commercialising ‘non-standard’ contractual rights in a creative production via a closed ‘over-the-counter’ marketplace, by providing a computer implemented method and system where ‘standard’ contractual rights in a creative production may be established and traded openly via centralised practices in a competitive ‘exchange’ marketplace.

Embodiments also seek to provide (i) an apparatus to facilitate the collaboration of parties around determining a proposed creative production, depicted as a previsualisation to manifest the concept of a creative production, one attribute at a time, by contract, before it is made into a creative production and fixed in a medium wherein it acquires copyright; and (ii) an apparatus to determine how a creative production will be exploited once it is realised (e.g. sports match captured by camera and broadcast to an audience) but with the terms of exploitation being determined, by contract, before it is realised when it is still a proposed creative production (e.g. sports match represented by a previsualisation like a storyboard, plan, etc).

In a first aspect there is provided a server processing system for facilitating transfer of rights to a portion of a proposed creative production, as embodied in contract, wherein the server processing system is configured to:

receive, from a first processing system, first data indicative of a depiction of the proposed creative production owned by a rightsholder and a selection of one or more portions of the proposed creative production, wherein rights associated with the selected one or more portions of the work, as embodied in contracts, are available for sale;

store the first data in a database;

receive, from a second processing system operated by a bidding party, search data indicative of a search query to identify rights, as embodied in contracts, to one or more portions of one or more proposed creative productions available for sale;

conduct a search of the database based on the search query;

transfer search results to the bidding party via the second processing system;

receive a bid to purchase the rights, as embodied in contracts, associated with at least some of the one or more portions of proposed creative production;

transfer the bid to the first processing system;

receive, from the first processing system, an acceptance of the bid by the rightsholder; and

store, in the database, transferred rights data indicative of the transfer of rights of the respective one or more portions of the proposed creative production from the rightsholder to the bidding party, wherein the bidding party can control the attributes, such as the presentation or broadcast, of the respective one or more portions of the proposed creative production in accordance with the rights purchased prior to being realised as a creative production and fixed in a medium.

In certain embodiments, the first data received from the first processing system is indicative of one or more attributes of the proposed creative production, wherein the search query received from the bidding processing system is indicative of one or more desired attributes.

In certain embodiments, the one or more attributes are indicative of a demographic audience and the one or more desired attributes is a desired demographic audience.

In certain embodiments, the server processing system is configured to host a website to enable the rightsholder and the bidding party to interact with the server processing system.

In certain embodiments, the server processing system is configured to receive first data from multiple first processing systems.

In certain embodiments, the server processing system receives one or a plurality of search requests from one or multiple second processing systems.

In certain embodiments, the proposed creative production is one of:

a moving visual work;

a digital work;

a printed work; and

an audio work.

In certain embodiments, the proposed creative production is a digital moving visual work, wherein the server processing system is configured to:

receive and store in the database a Uniform Resource Locator (URL) associated with the bidding party;

receive and store a copy of the digital moving visual work which has been created; and

enable presentation of a media player viewable by a viewing processing system, wherein the media player is configured to present the digital moving visual work via the viewing processing system, wherein the media player includes:
a first portion for presenting the digital moving visual work;
a second portion for presenting a digital object associated with the bidding party, wherein the digital object is presented via the viewing processing system when the one or more portions of the digital moving visual work associated with the bidding party are visible during playback of the digital moving visual work and the digital object is related via a Uniform Resource Locator (URL) to a database on a server processing system owned or controlled by the bidding party.

In a second aspect there is provided a method for facilitating transfer of rights to a portion of a proposed creative production, embodied by contracts, wherein the method includes:

a server processing system receiving, from a first processing system, first data indicative of a depiction of the proposed creative production owned by a rightsholder and a selection of one or more portions of the proposed creative production, wherein rights associated with the selected one or more portions of the proposed creative production are available for sale;

the server processing system storing the first data in a database;

the server processing system receiving, from a second processing system operated by a bidding party, search data indicative of a search query to identify rights to one or more portions of one or more proposed creative productions available for sale;

the server processing system conducting a search of the database based on the search query;

the server processing system transferring search results to the bidding party via the second processing system;

the server processing system receiving a bid to purchase the rights associated with at least some of the one or more portions of proposed creative production;

the server processing system transferring the bid to the first processing system;

the server processing system receiving, from the first processing system, an acceptance of the bid by the rightsholder; and

the server processing system storing, in the database, transferred rights data indicative of the transfer of rights of the respective one or more portions of the proposed creative production from the rightsholder to the bidding party, wherein the bidding party can control the presentation or broadcast of the respective one or more portions of the proposed creative production when created in accordance with the rights purchased, as embodied in contract.

In certain embodiments, the first data received from the first processing system is indicative of one or more attributes of the proposed creative production, wherein the search query received from the bidding processing system is indicative of one or more desired attributes.

In certain embodiments, the one or more attributes are indicative of a demographic audience and the one or more desired attributes are a desired demographic audience.

In certain embodiments, the method includes the server processing system hosting a website to enable the rightsholder and the bidding party to interact with the server processing system.

In certain embodiments, the method includes the server processing system receiving first data from multiple first processing systems.

In certain embodiments, the method includes the server processing system receiving one or a plurality of search requests from one or multiple second processing systems.

In certain embodiments, the proposed creative production is one of:

a moving visual work;

a digital work;

a printed work; and

an audio work.

In certain embodiments, the proposed creative production is a digital moving visual work, wherein the method includes:

the server processing system receiving and storing in a database requests via a Uniform Resource Locator (URL) associated with the bidding party;

the server processing system receiving and storing a copy of the digital moving visual work which has been created; and

the server processing system enabling presentation of a media player viewable by a viewing processing system, wherein the media player is configured to present the digital moving visual work via the viewing processing system, wherein the media player includes:
a first portion for presenting the digital moving visual work;
a second portion for presenting a digital object associated with the bidding party, wherein the digital object is presented via the viewing processing system when the one or more portions of the digital moving visual work associated with the bidding party are visible during playback of the digital moving visual work and the digital object may be related via a Uniform Resource Locator (URL) to a database on a server processing system owned or controlled by the bidding party.

In a third aspect there is provided a system for facilitating transfer of rights, as embodied in contracts, to a portion of a proposed creative production, wherein the system includes:

a first processing system;

a second processing system; and

a server processing system configured according to the first aspect.

In a fourth aspect there is provided a non-transitory computer readable medium including executable instructions, wherein execution of the executable instructions configure a server processing system to facilitate transfer of rights to a portion of a proposed creative production, as embodied in contracts, wherein execution of the executable instructions configure the server processing system to:

receive, from a first processing system, first data indicative of a depiction of the proposed creative production owned by a rightsholder and a selection of one or more portions of the proposed creative production, wherein rights associated with the selected one or more portions of the proposed creative production, as embodied in one or more contracts, are available for sale;

store the first data in a database;

receive, from a second processing system operated by a bidding party, search data indicative of a search query to identify rights, as embodied in contracts, to one or more portions of one or more proposed creative productions available for sale;

conduct a search of the database based on the search query;

transfer search results to the bidding party via the second processing system;

receive a bid to purchase the rights, as embodied in contracts, associated with at least some of the one or more portions of a proposed creative production;

transfer the bid to the first processing system;

receive, from the first processing system, an acceptance of the bid by rightsholder; and

store, in the database, transferred rights data indicative of the transfer of rights of the respective one or more portions of the proposed creative production from the rightsholder to the bidding party, wherein the bidding party can control the presentation or broadcast of the respective one or more portions of the proposed creative production when created in accordance with the rights purchased, as embodied by any contracts.

In a fifth aspect there is provided a server processing system for facilitating transfer of rights to a portion of a proposed creative production, wherein the server processing system is configured to:

receive, from a first processing system, first data indicative of a depiction of the proposed creative production owned by a rightsholder and a selection of one or more portions of the proposed creative production, wherein rights associated with the selected one or more portions of the proposed creative production, as embodied in one or more contracts, are available for sale;

store the first data in a database;

receive, from a second processing system operated by a bidding party, search data indicative of a search query to identify rights to one or more portions of one or more proposed creative productions available for sale;

conduct a search of the database based on the search query;

transfer search results to the bidding party via the second processing system;

receive a bid to purchase the rights, as embodied in contracts, associated with at least some of the one or more portions of proposed creative production;

transfer the bid to the first processing system;

receive, from the first processing system, an acceptance of the bid by rightsholder; and

store, in the database, transferred rights data indicative of the transfer of rights of the respective one or more portions of the proposed creative production from the rightsholder to the bidding party, wherein the bidding party can control the presentation or broadcast of the respective one or more portions of the proposed creative production when created in accordance with the rights purchased, as embodied by any contracts.

In a sixth aspect there is provided a method for facilitating transfer of rights, as embodied by contracts, to a portion of a proposed creative production, wherein the method includes:

a server processing system receiving, from a first processing system, first data indicative of a depiction of the proposed creative production owned by a rightsholder and a selection of one or more portions of the proposed creative production, wherein rights, embodied by contracts, associated with the selected one or more portions of the proposed creative production are available for sale;

the server processing system storing the first data in a database;

the server processing system receiving, from a second processing system operated by a bidding party, search data indicative of a search query to identify rights, as embodied by contracts, to one or more portions of one or more proposed creative productions available for sale;

the server processing system conducting a search of the database based on the search query;

the server processing system transferring search results to the bidding party via the second processing system;

the server processing system receiving a bid to purchase the rights, as embodied by contracts, associated with at least some of the one or more portions of proposed creative production;

the server processing system transferring the bid to the first processing system;

the server processing system receiving, from the first processing system, an acceptance of the bid by rightsholder; and

the server processing system storing, in the database, transferred rights data indicative of the transfer of rights, as embodied by contracts, of the respective one or more portions of the proposed creative production from the rightsholder to the bidding party, wherein the bidding party can control the presentation or broadcast of the respective one or more portions of the proposed creative production when created in accordance with the rights purchased, as embodied by contracts.

In a seventh aspect there is provided a system for facilitating transfer of a right, as embodied by a contract, to a portion of a proposed creative production, wherein the system includes:

a first processing system;

a second processing system; and

a server processing system configured according to the fifth aspect.

In an eighth aspect there is provided a non-transitory computer readable medium including executable instructions, wherein execution of the executable instructions configure a server processing system to facilitate transfer of rights, as embodied by contracts, to a portion of a proposed creative production wherein execution of the executable instructions configure the server processing system to:

receive, from a first processing system, first data indicative of a depiction of the proposed creative production owned by a rightsholder and a selection of one or more portions of the proposed creative production, wherein rights, embodied by contracts, associated with the selected one or more portions of the proposed creative production are available for sale;

store the first data in a database;

receive, from a second processing system operated by a bidding party, search data indicative of a search query to identify rights to one or more portions of one or more proposed creative productions available for sale;

conduct a search of the database based on the search query;

transfer search results to the bidding party via the second processing system;

receive a bid to purchase the rights, as embodied by contracts, associated with at least some of the one or more portions of proposed creative production;

transfer the bid to the first processing system;

receive, from the first processing system, an acceptance of the bid by rightsholder; and

store, in the database, transferred rights data indicative of the transfer of rights, as embodied by contracts, of the respective one or more portions of the proposed creative production from the rightsholder to the bidding party, wherein the bidding party can control the presentation or broadcast of the respective one or more portions of the proposed creative production when created in accordance with the rights purchased, as embodied by contracts.

In a ninth aspect there is provided a server processing system for facilitating presentation of a media player interface, wherein the server processing system is configured to:

receive a request, from a viewing processing system, to view a digital moving visual work; and

enable presentation of a media player interface viewable by a viewing processing system, wherein the media player interface is configured to present the digital moving visual work via the viewing processing system, wherein the media player interface includes:
a first portion for presenting the digital moving visual work; and
a second portion for presenting a digital object associated with the rightsholder who owns a right to a portion of a digital visual work, wherein the digital object is presented by the viewing processing system when the one or more portions of the digital moving visual work associated with the party are visible during playback of the digital moving visual work.

In certain embodiments, the server processing system transfers rights data indicative of a time period of the portion of the digital moving visual work which the rightsholder owns, wherein the viewing processing system interprets the rights data to present the digital object within the second portion of the media player interface according to the time period defined by the rights data.

In certain embodiments, the server processing system transfers boundary data indicative of a boundary of the digital moving visual work presented within the first portion of the media player interface which is associated with the rightsholder, wherein is response to a viewing user interacting with a portion of the digital moving visual work within the boundary results in an action being performed in relation to the digital object of the rightsholder.

In certain embodiments, the action performed includes the digital object of the rightsholder being highlighted within the second portion of the media player interface.

In certain embodiments, the action performed includes presenting a webpage associated with the rightsholder via the viewing processing system.

In a tenth aspect there is provided a method for facilitating presentation of a media player, wherein the method includes:

receiving a request, from a viewing processing system, to view a digital moving visual work; and

enabling presentation of a media player interface viewable by a viewing processing system, wherein the media player interface is configured to present the digital moving visual work via the viewing processing system, wherein the media player interface includes:
a first portion for presenting the digital moving visual work; and
a second portion for presenting a digital object associated with the rightsholder who owns a right to a portion of a digital visual work, wherein the digital object is presented by the viewing processing system when the one or more portions of the digital moving visual work associated with the party are visible during playback of the digital moving visual work.

In certain embodiments, the method includes the server processing system transferring rights data indicative of a time period of the portion of the digital moving visual work which the rightsholder owns, wherein the viewing processing system interprets the rights data to present the digital object within the second portion of the media player interface according to the time period defined by the rights data.

In certain embodiments, the method includes the server processing system transferring boundary data indicative of a boundary of the digital moving visual work presented within the first portion of the media player interface which is associated with the rightsholder, wherein is response to a viewing user interacting with a portion of the digital moving visual work within the boundary results in an action being performed in relation to the digital object of the rightsholder.

In certain embodiments, the action performed includes the digital object of the rightsholder being highlighted within the second portion of the media player interface.

In certain embodiments, the action performed includes presenting a webpage associated with the rightsholder via the viewing processing system.

In an eleventh aspect there is provided a non-transitory computer readable medium for facilitating presentation of a media player, wherein the non-transitory computer readable medium includes executable instructions which, when executed by a server processing system, configure the server processing system to:

receive a request, from a viewing processing system, to view a digital moving visual work; and

enable presentation of a media player interface viewable by a viewing processing system, wherein the media player interface is configured to present the digital moving visual work via the viewing processing system, wherein the media player interface includes:
a first portion for presenting the digital moving visual work; and
a second portion for presenting a digital object associated with the rightsholder who owns a right to a portion of a digital visual work, wherein the digital object is presented by the viewing processing system when the one or more portions of the digital moving visual work associated

In certain embodiments, the server processing system is configured to transfer rights data indicative of a time period of the portion of the digital moving visual work which the rightsholder owns, wherein the viewing processing system interprets the rights data to present the digital object within the second portion of the media player interface according to the time period defined by the rights data.

In certain embodiments, the server processing system is configured to transfer boundary data indicative of a boundary of the digital moving visual work presented within the first portion of the media player interface which is associated with the rightsholder, wherein is response to a viewing user interacting with a portion of the digital moving visual work within the boundary results in an action being performed in relation to the digital object of the rightsholder.

In certain embodiments, the action performed includes the digital object of the rightsholder being highlighted within the second portion of the media player interface.

In certain embodiments, the action performed includes presenting a webpage associated with the rightsholder via the viewing processing system.

Other aspects and embodiments will be appreciated throughout the detailed description of the preferred embodiments.

### BRIEF DESCRIPTION OF THE DRAWINGS

Aspects and features of the disclosed embodiments and their implementation may be better understood from the following description, which is given by way of example only, of at least one preferred but non-limiting embodiment, presented with reference to the accompanying drawings, in which:

FIG. 1 is a simplified block diagram of an example system according to various embodiments;

FIG. 2 is an example of a previsualisation of a proposed creative production;

FIG. 3 is a flowchart representing an example method of receiving and storing a previsualisation of a proposed creative production;

FIG. 4a is an exemplary embodiment of a previsualisation for a future film;

FIG. 4b is an exemplary embodiment of a previsualisation for a future magazine issue;

FIGS. 5a to 5h show an example interface for a user defining an attribute, and subsequently the right, as embodied in a contract, in a proposed creative production using the proxy of the previsualisation through a number of steps;

FIG. 6 show a flowchart representing an example logic flow by which one or more contracts are created to embody certain legal rights associated with a proposed creative production, as portrayed by the proxy of a previsualisation of the creative production;

FIG. 7 is a block diagram of an exemplary media engine;

FIG. 8 is a block diagram of an exemplary matching engine;

FIG. 9 is a example user interface generated by an order book module;

FIG. 10 is a flowchart representing an example method of placing a bid and accepting a bid;

FIG. 11 is a block diagram of a publishing engine;

FIGS. 12a to 12g are examples of a media player in various states for presenting the proposed creative production that has been created and any digital objects associated with the bidding party, such as for example, via a URL linked to a database on a server processing system owned or controlled by the bidding party;

FIG. 12h is a schematic of an example media player interface for presenting the digital work; and

FIG. 13 is a flowchart representing an exemplary method for facilitating the transfer of rights, as embodied in contracts, in relation to a proposed creative production.

### DETAILED DESCRIPTION

Embodiments provide a computer implemented method and system designed to enable producers of creative productions to secure finance, and any other benefits, from interested parties in exchange for legal rights in creative productions, as embodied in standard contracts. Various attributes of a creative production may be of value to interested parties, with the value depending on the creative production and the level of demand from interested parties. By establishing a standard contractual arrangement in relation to an attribute of a creative production and determining a value for that standardised contract in a competitive marketplace early in the production process, before the creative production is fixed in a medium, the producer of the creative production may be able to garner sufficient economic support so that production of the creative production can progress.

In one embodiment, consider a proposed film production. In order to produce the film the filmmaker may require financial support or products and services for the production. Say, for example, the film production will require clothing for an actor in a particular scene. There may be several clothing suppliers willing to pay for the right to provide the required clothing items in exchange for certain benefits, such as the publicity resulting from the final production. This is a form of sponsorship, sometimes referred to as ‘product placement’.

Sponsorship in general is a commercial arrangement wherein a cash or in-kind fee is paid to a sponsored party in return for access to an exploitable commercial potential associated with the sponsored party's production. In the context of creative productions, the exploitable commercial potential may comprise product placement rights (which may exist ‘ex ante’, or prior to a creative production being fixed in a medium, and ‘in situ’, or inside a creative production). Another example of exploitable commercial potential may comprise character or talent endorsement rights (which may exist ‘ex situ’, or outside a creative production), effected through participation in an advertising campaign produced by the clothing supplier. Another example again of exploitable commercial potential may comprise a broadcast right or distribution right or exhibition right (which may exist ‘ex post’, or after a copyright is fixed in a medium), effected through delivery of the creative production to any audience by, for example, encoding or formatting standards used to the transmit or receive creative production via any telecommunication like terrestrial transmission, digital terrestrial transmission, cable transmission, satellite transmission, or transmission via the internet protocol suite on the Internet, World Wide Web or similar computer networks.

Traditionally, contracts for such commercial arrangements tend to be brokered between parties in person, bilaterally and settled using bespoke agreements after terms have been effectuated via negotiation. It takes time and effort for a rightsholder to find a counterparty interested in negotiating a contract around an attribute in a proposed creative production, and vice versa. It takes time and effort to negotiate terms, and more time and effort to draft a contract between parties based on agreed terms. Thus, if counterparties are matched then any settlement incurs a high transaction cost because a contract must be uniquely created. In this way, negotiating contracts around attributes in proposed creative production is tedious, time consuming and manual. The high search and transaction costs mean fewer contracts are written. This results in an underinvestment in the creation of creative production, which imposes a deadweight loss on society such that the net effect is a suppression of social benefits like self-expression, creative employment or cultural diversity.

In contrast, a system and method is described herein in which a right is first ‘created’ and then sold. It is created in the sense that a registered rightsholder issues a standard contract, or a formally executed standard written contract document, as an embodiment of the legal right. This is done by assigning a legal right in an attribute of a proposed creative production to a standard contract according to procedures set forth in a relevant Copyright Act or related laws. Many contracts are available for selection on the system to a registered participant, from a menu of available options, each discoverable via search. Each contract has its own characteristics and structure. It is previously prepared as a standard legal document that serves as the definiendum, or the subject, for a specific legal right. For example, a standard legal document may exist on the system that serves as the subject of a ‘broadcast right’, such that this broadcast right then becomes the definien for this standard contract. Each contract then gives rise to an asset of one entity and a liability of another, for every legal right. Upon assigning a specific legal right in an attribute of a proposed creative production to a specific contract, the rightsholder takes beneficial ownership of the contract which they have created, or issued, until it is sold or annulled by them, subject to any terms of the contract. As a non-traditional commodity, each contract is considered a tradable asset that can be exchanged like a good on the system many times over for a mark-to-market price set by those other parties registered on the system willing to trade in that contract. In this way, the rightsholder of a proposed creative production ‘creates a right’ against an attribute of a proposed creative production which, effectively, may also be considered as a specific decision they are willing to share or delegate with respect to that proposed creative production and then allows for that shared or delegated decision to be owned by the holder of the relevant contract in which it is embodied. In this way any decision about a proposed creative production can be acquired by purchase or divested by sale of a contract, via a standard contract of sale. Since the process of creating rights on the system is automated, contracts can be made to hold granular decisions in proposed creative production. In turn, decisions can be federated over a wide portfolio of stakeholders.

In one embodiment the system offers a technical solution to enable a producer of a proposed creative production to arrange contracts in relation to the production of the work. Specifically, a computer implemented system and method is described by which:

Producers are provided with a structured way of converting creative production attributes into contracts, such as sponsorships;

Potential sponsors are provided with a structured way to search, find and buy contracts, like sponsorships, issued against creative production attributes;

Details about matching supply and demand of contracts may be determined in part via an automated and competitive bidding process; and

A trading market to facilitate the divestment or purchase of contracts issued against attributes in creative productions.

In another embodiment, an example of a contract is a product placement contract right that obliges the producer of a creative production to place an artifact (e.g. prop, talent, location, etc) into a scene under defined terms so as to be recorded onto camera and appear on screen.

In another embodiment, an example of a contract is a product integration contract right that obliges the producer of a creative production to integrate an artifact (e.g. prop, talent, etc) into a scene under defined terms so as to be recorded onto camera and appear on screen.

In another embodiment, an example of a contract is a talent endorsement contract right or a character endorsement contract right that obliges the producer of a creative production to place either a talent or character from a scene into an advertising campaign (which may or may not be related to a film property) under defined terms.

In another embodiment, an example of a contract is a broadcast contract right or distribution contract right or exhibition contract right that obliges the producer to permit the holder of the contract to broadcast or distribution or exhibit the creative production to an audience using any telecommunication under defined terms; such as technology (e.g. terrestrial broadcast, etc.), territory (e.g. Australia), period (e.g. Summer 2015), etc.

In another embodiment, an example of a contract is an options contract right (e.g. broadcast option, etc.) which obliges the issuer to deliver, transfer or license a legal right (e.g. broadcast right, etc.) in a proposed creative production for a specified price if a valid counterparty chooses to exercise the option on or before an expiration date, under defined terms.

In another embodiment, an example of a contract is a default swap contract right which may oblige an issuer to financially settle with a holder of an options contract under defined terms; such as in the event of a predefined default trigger like the failure of the issuer of the options contract to deliver a creative production.

In another embodiment, an example of a contract is a collateralised obligation contract right (e.g. bond, mortgage, etc.) that may oblige an issuer to transfer cashflows from a creative production under defined terms, such as a defined period of time at a fixed rate.

Embodiments provide a means to coordinate contracts issued against attributes in creative production, by operating as a data processing system to trade said contracts. Specifically, a screen-based electronically automated financial exchange and trading system is provided for the trade of standardised contracts based on proposed creative production depicted by a previsualisation on the system. The system is a designated marketplace for contracts. It facilitates the union of sellers and buyers of contracts in an open, competitive, and efficient marketplace in order to match counterparty orders. The system manages matters pertaining to contracts, legal rights, use of previsualisations to presently portray proposed creative productions and chains of title in any creative productions. It lists all manner of contracts; stores and retrieves the best current bid or ask contract prices; qualifies buy or sell orders; settles orders; and reports particulars. It promotes price discovery and price risk management. The system provides a hedging function to market participants and creates opportunities to raise capital for the production of new creative production. All of this helps entrepreneurs produce new creative productions that foster certain social benefits, like employment.

A feature of the system is that it decouples contracts from being written after a transaction is made. Whereas traditionally a contract was written after terms were agreed, a contract can now be written first, before parties enter a deal. In this way, by existing before a transaction, the contract becomes the basis for the deal. The contract is defined against a previsualisation of a proposed creative production. Each contract is a tradable asset, or a non-traditional commodity; possession of which shows evidence of a lawful interest in a proposed creative production. This is because the creative production on which it is based has an underlying cash market. Thus, the contract is defined according to International Accounting Standard 32 and 39 as ‘a contract that gives rise to a financial asset of one entity and a financial liability of another entity’. In this way, the system can also be called a commodities exchange as it gives authors of creative productions access to many more prospective deal partners with whom to decide attributes in a creative production.

Previsualisations of proposed creative production are recorded onto the system by digital media file (e.g. digital image, digital video, digital audio, digital text, computer-simulated life, computer-aided design, or similar) sorted by parameters, such as; previsualisation type (e.g., storyboard, script, format, prototype, virtual reality, patent, etc.); general details (e.g. title, release dates/regions, target demographics, etc.); state of development (e.g. pre-production, production, post-production, etc.), aspect (e.g., scene, page, plane, etc.); attribute (e.g., prop, wardrobe, etc.), news (e.g., changes in attributes, etc.), and similar.

The system ‘tags’ a previsualisation by assigning information to it using a graphical notation in order to issue any one of many standardised contracts; such as for example, placement rights, integration right, endorsement right and broadcast right, each defined against a previsualisation. As the system is founded on the principles of an order driven market, it can offer a variety of exchange-traded contracts. In other embodiments, methods and systems disclosed herein may include additional elements, steps, instructions or data structures in respect of other contracts.

As used herein, the terms ‘buy’ and ‘sell’ refer to the trade of standard contracts between buyer and seller members registered on the system, also called traders. Traders are clients of the system. When a trader buys a standard contract from a seller on the system, title in that contract is transferred from one to the other, and respective member accounts are debited/credited. Member accounts may record various details, including identifier, name, trade details, gains/losses, balances, chains of title, and similar. Market forces mediated on the system determine the fair value of each contract. The market price is variable and adjusted on a mark-to-market basis. It is updated continuously, at regular intervals, at predetermined periods, on specified dates/times, or any other known or later developed convention for updating a market price.

Embodiments also provide a method and system for real-time trading. In particular a system for real-time trading of standard contracts, or rights, between a plurality of traders over a computer network, such as the Internet, is disclosed. The system includes a computer network, a market server, and a plurality of trader clients (referred to herein as ‘keystations’), which can be operated by two or more human traders. The market server is connected to the computer network. The market server can match and process trade orders in substantially real-time. Keystations are connected to the computer network so that each keystation can communicate with the market server and each other. Each keystation transmits commands in substantially real-time to the market server and displays substantially real-time data updates from the market server. Each keystation can provide additional information to a human trader, such as an underlying previsualisation as received from a server.

Real-time trading includes entering an ask order, from a seller, for a contract, or right, onto an electronic order book via a keystation. The system associates the ask order with a counter bid order for a contract. The bid order is associated with a buyer. Orders are qualified for execution by comparing their details with stored parameters, as set by market rules. Orders wait until an electronic matching engine recommends matches for execution. Suggested matches between ask and bid orders are made using proprietary logic, as set by market rules. Matches can be programmed by traders to be accepted either automatically or manually. Parties to a transaction on the system may be unknown to each other until matched, but then known to each other before a trade is settled. A trade may be executed automatically in response to programmed logic, such as the bid value not being less than the ask value.

The matching engine is a computer-implemented algorithm that uses proprietary logic to determine the conditions at which orders are matched. To facilitate an exchange, the matching engine works to find a best fit within defined parameters, such as the best bid and ask prices for each qualified order for a standard contract. As per market rules, execution of a trade may be conditional wherein, for example, a recommended match must be ratified by a rightsholder, either by automatic or manual consent. In this case, once the rightsholder gives consent, the match is said to be valid. Once the seller or buyer accepts a match, any parameters are updated and reported to traders.

In this way, the copyright exchange provides an automated electronic trading platform where listed contracts can be traded between sellers and buyers. Just as the system gives sellers a means to find buyers, it also gives buyers an efficient means to become sellers in order to divest and exit positions if their strategy so requires. Thus, the system works as a marketplace and facilitates improved counterparty coordination. This makes it possible for members to participate in the welfare of a proposed creative production in a similar way to how people might participate in the welfare of a company through a computer-implemented securities exchange.

Keystation commands may include trade orders wherein the market server distributes trade orders and any executions to other keystations in substantially real-time. Each keystation can facilitate the entry of commands by providing any one of multiple entry methods to aid submission of commands. One such entry method may involve using graphical user interface principles. The keystation may facilitate command entry by providing a proprietary order entry language to interface with a keystation to, for example; submit commands to the market server; act upon commands submitted from multiple keystations to the market server, or display information from the market server regarding a submitted command. Traders enter commands submitted to the market server via the keystations. Commands so entered can be issued from any trader in regards to any proposed creative production depicted by a previsualisation.

Information from the market server about submitted commands related to the underlying proposed creative production, or commodity, and resulting server actions can be displayed in substantially real-time on some or all of the keystations. Information so displayed may be parsed into multiple windows depending upon any number of parameters.

Any of various market rules may act upon commands submitted by a trader via a keystation, such as for example; trade order commands may be precluded from execution if insufficient credit is available in a members account; trade order commands may be validated prior to being further acted upon, such as by a third party; or, trade order commands of at least two traders may be matched according to a set of market rules.

For specificity, but without limit, it is assumed that traders comprise both end user clients, (also known as stakeholders such as advertisers, marketers, brand managers, or similar), and market making specialist clients (also known as broker-dealers or specialists such as design studios, creative agencies, public relations agencies, event producers, media agencies, law firms, or similar). Specialists are a class of client who provide end user clients access to the system. In this way, specialists may work between end user clients and the system.

Specialists access the platform directly through a subscriber keystation interface to make a market for a listed contract. Clients of specialists, namely stakeholders, may access the trading platform through a non-subscriber keystation interface hosted by a specialist. Thus, while specialists subscribe directly to the system, stakeholders subscribe indirectly via specialists. Both specialists and stakeholders may log order details into the platform within relevant parameters, such as; general details (e.g. title, release dates/regions, etc.), attributes (e.g., prop, page, genre, target demographics, talent, locations, etc.), status (e.g., development, pre-production, production, post-production, release, etc.), news (e.g., attribute changes, etc.), order type (buy, sell), contract class (e.g. right, derivative, etc.), contract kind (e.g., production, broadcast, etc.), contract type (e.g. option, default swap, bond, etc.), contract bid/ask price, and similar.

Specialists make a market for a contract by accepting the risk to hold it and the obligation of making a price in each contract they hold. Specialists control order flow into the system by accommodating the trading wishes of stakeholders. They sell to buyers and buy from sellers and compete for stakeholder customers by making buy or sell price quotations for contracts in which they make a market. Prices are reported via a quotation system or as part of any one of various indices, visible through a keystation. Once a specialist receives an order, they sell from their own inventory or seek an offsetting order. They are compensated by means of the bid-ask spread differentials between prices they set in return for the service of providing liquidity, reducing transaction costs and facilitating trade.

Contracts listed on the system may be written, guaranteed or settled by a third party called a clearinghouse. The clearinghouse regulates and closely monitors the system in order to uphold just and equitable principles of trade so as to protect traders and the public. The clearinghouse mitigates risk, builds an active marketplace and fosters market integrity. It may do this by mutualising the risk of default across members. To this end, the clearinghouse may accredit each member to uphold system integrity. It uses surveillance, investigation, prudential supervision and systemic risk controls to oversee the processes by which the system ensures fair and equitable trading. The clearinghouse is a buyer to every specialist seller and a seller to every specialist buyer. In this way, it holds two offsetting positions by letting parties transact with a clearing entity instead of individuals. This fosters market integrity. The clearinghouse efficiently concentrates the risk of settlement failures into itself and so isolates any effects of counterparty risk from the system.

The clearinghouse can generate various reports to traders, such as for example; particulars of every match; whether a recommended match was cleared; price at which a match was settled; contract type; underlying asset details, and the like. Other performance indicators can also be reported by the system such as, for example, trading volume (e.g. contracts traded daily); total trade value (e.g. total market capitalisation at end of day); number of specialists; number of stakeholders; total number of all traders participating on the system, and the like.

If a sell order is matched with a buy order and any market rules are satisfied; such as the author of the proposed creative production approves the match and a clearinghouse clears the traders; then a matching event may be said to occur and a trade can be executed. An executed trade is known as a settlement, which means monies are paid from buyer to seller via the clearinghouse. Settlement of contracts, namely, payment from buyer to clearinghouse, can occur over a period range. Upon settlement, the clearinghouse may request specialists pay either the full amount owed or a portion of the amount owed with any balance payable by a due date, depending on a rating assigned to the specialist by the clearinghouse. The portion, or margin, payable at a future date may differ for each specialist based on their rating and any rules set by the clearinghouse, which may take into consideration relationship standing or cash reserves. The margin may range from zero to one hundred percent of monies payable.

Upon settlement, an attribute of a proposed creative production changes status from being preferred by the author to being expected, and therefore determined, in a previsualisation, which serves as a present day proxy for the proposed creative production. Based on the expected attribute, a work can then be produced and published. In this way, embodiments may help an author efficiently determine one or more attributes in a proposed creative production before they produce or publish it.

FIG. 13 is a flowchart diagram representing an overall method for facilitating the transfer of rights in relation to one or more portions of a proposed creative production, in accordance with an embodiment. The sequence of operations is outlined below. In operation 1310, a server processing system receives, from a first processing system, first data indicative of a depiction of the proposed creative production owned by a rightsholder and a selection of one or more portions of the proposed creative production, wherein rights associated with the selected one or more portions are available for sale. In operation 1320, the server processing system stores the first data in a database. Operation 1330 involves the server processing system receiving, from a second processing system operated by a bidding party, search data indicative of a search query to identify rights to one or more portions of one or more proposed creative productions available for sale. In operation 1340, a search of the database is conducted based on the search query. Operation 1350, involves transferring search results to the bidding party via the second processing system. In operation 1360, the server processing system receives a bid to purchase the rights associated with at least some of the one or more portions of proposed creative production. The bid is then transferred to the first processing system (operation 1370). In operation 1380, the first processing system receives an acceptance of the bid by the rightsholder. Finally, operation 1390 involves storing, in the database, transferred rights data indicative of the transfer of rights of the respective one or more portions of the proposed creative production from the author to the bidding party, wherein the bidding party can control the presentation of the respective one or more portions of the proposed creative production when published in accordance with the rights purchased.

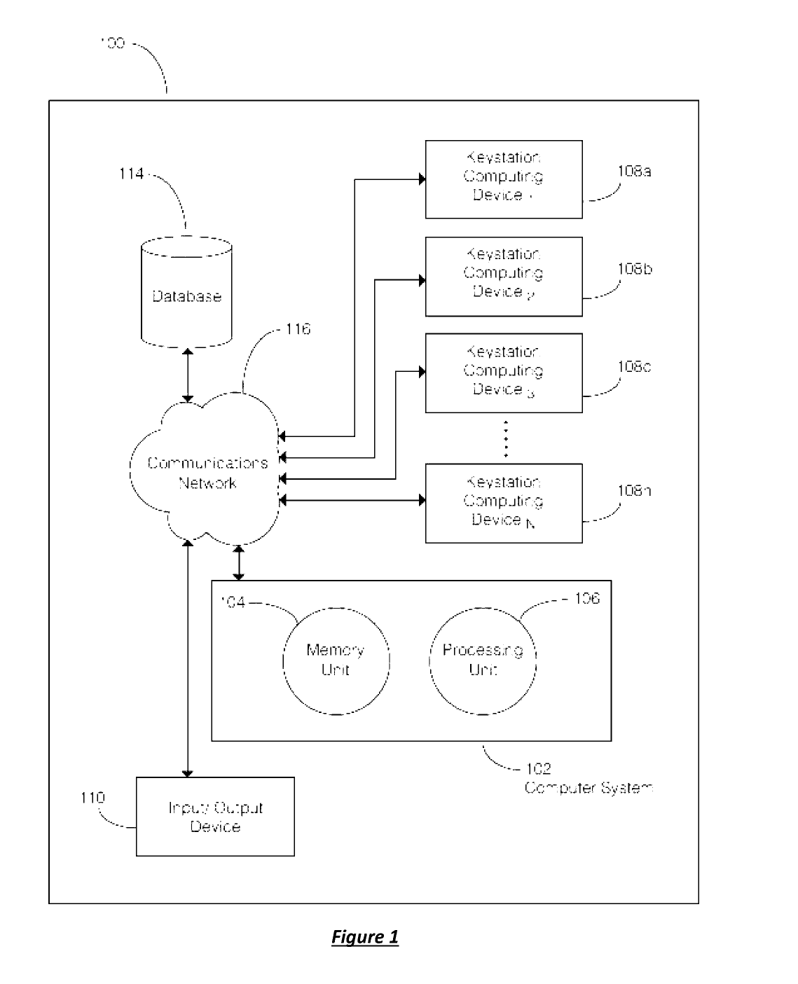

An example of a suitable technical operating environment 100 in which various aspects may be implemented is shown in FIG. 1. This environment is only one example of a suitable environment and is not intended to suggest any limit as to the scope of use or functionality of the disclosed embodiments. Within this environment, a processing unit 106 of a computer system 102 executes computer-executable instructions to provide functionality as disclosed herein. A memory unit 104 may store computer-executable instructions, which are executed by the computer system 102. The computer-executable instructions may be comprised of one or more modules, or engines. Engines may be accessed using a keystation. The computer system 102 may be connected to one or more keystation computing devices 108 (e.g., personal computer, handheld computer, wearable computer, etc.) or input/output devices 110 (e.g., microphone, mouse, trackball, track pad, keyboard, screen, television, speaker, computer, etc.). A database 114 may contain, for example, information useful in defining a previsualisation or contract. The database 114, computer system 102, keystation computing devices 108 or input/output devices 110 may be connected through a wired or wireless communications network 116.

Any data processing apparatus known to those skilled in the art may implement the system; such as any common bus system interconnecting one or more electronic processors, data input apparatus, machine-readable memory and data output apparatus. Thus, numerous processing units, memory units, databases, devices or keystations may comprise the technical operating environment 100. The system may be further implemented by one or more sets of computer-executable instructions embodying the methods as described, residing on any memory unit 104. The system may also be accessible globally via any network 116, such as the Internet, and embodied as a web-based electronic platform. The environment 100 portrayed is only indicative of a suitable operating environment and is not intended to suggest a limit as to the scope of use or functionality of the solution. One skilled in the art will appreciate the topology shown in FIG. 1 is exemplary and components shown may be related by numerous alternative topologies to reflect various embodiments.

In one embodiment, a user of a keystation computing device 108 may contact the computer system 102 via a communications network 116, such as the Internet, and upload one or more digital media files as previsualisations of a proposed creative production. The user can then use the embodiment to define standard contracts against the media files. In another embodiment, a user of a keystation may enter an order for a standard contract available on the system and indicate a bank account to transfer cash relating to a settlement. In yet another embodiment, a user of a keystation may upload a produced creative product, in the form of a digital media file, and publish it using a specifically structured media player that embodies the work and means to engage with attributes in the work via an output device 110.

In order to facilitate the arrangement of sponsorship contracts between potential sponsors and creative work producers in a structured and conveniently computer-implemented manner, the previsualisation of a proposed creative production with one or more determined attributes is published, or fixed, in a medium via a proprietary media player that can embody both the creative production and the means to engage with attributes in the creative production.

Various embodiments include computer-implemented programming instructions that function inside a technical operating environment. As these embodiments are described with reference to text and drawings, various modifications or adaptations of the systems, methods and specific structures described may become apparent to those skilled in the art. All such modifications, adaptations, or variations that rely upon the teachings of the disclosure, and through which these teachings have advanced the art, are considered to be within the spirit and scope of the disclosure. Hence, these descriptions and drawings should not be considered in a limiting sense, as it is understood that the invention is in no way limited to only the embodiments illustrated.

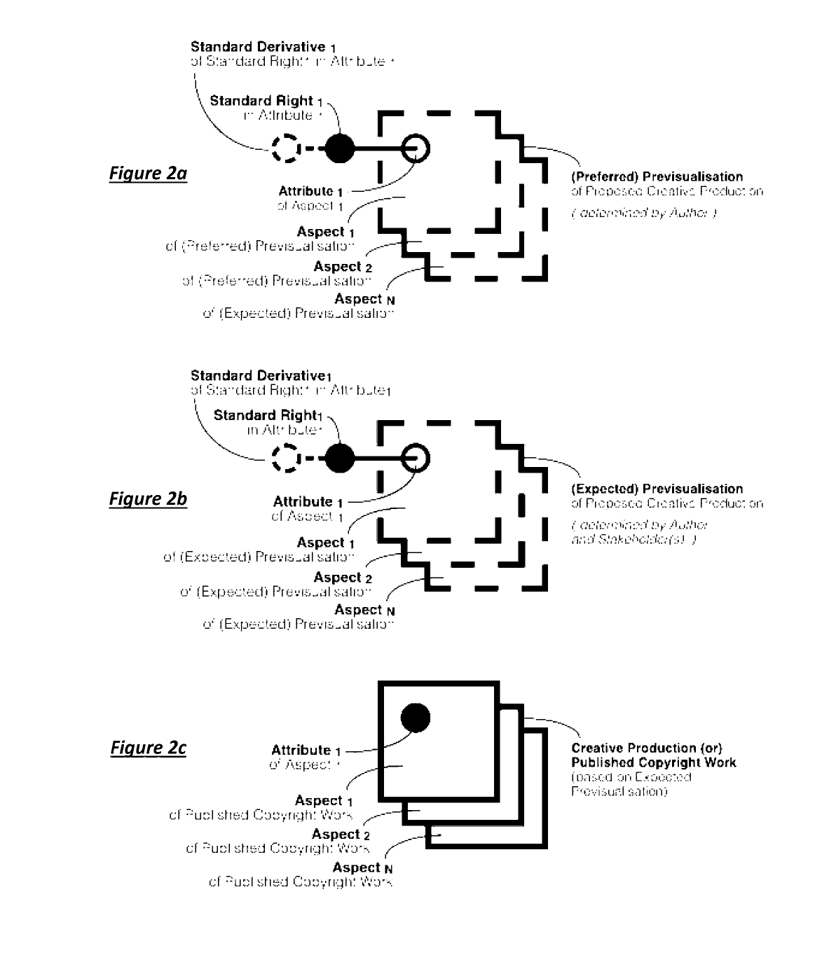

FIG. 2 depicts the common elements of a previsualisation, as employed in various embodiments. In this way, it defines a previsualisation as the sum of one or more aspects, where each aspect is the sum of one or more attributes. FIG. 2 diagrammatically illustrates how a standard right is defined against an attribute, within an aspect, and how a standard derivative is defined against a standard right. Standard rights and standard derivatives are collectively referred to as standard contracts, which are regarded as tradable assets or non-traditional commodities on the system.

FIG. 2 discloses a previsualisation with two states, before (FIG. 2a) and after (FIG. 2b) the system determines attributes of a proposed creative production. The first state of the previsualisation (FIG. 2a) reveals attributes preferred by the author. The second state (FIG. 2b) reveals attributes determined by the system, as guided by the preferences of the author. FIG. 2 also reveals a published work (FIG. 2c) made from the expected attributes of a previsualisation (FIG. 2b), as determined by the system. Examples of attributes include, but are not limited to: the ability for a work or part thereof to be produced; the ability of a work or part thereof to be reproduced; the ability of a work or part thereof to be to performed; the ability of a work or part thereof to be exhibited; the ability of a work or part thereof to be to broadcast; and similar.

FIG. 2 reveals that a previsualisation may undergo iterative change between a notional preferred state (FIG. 2a) and an expected state (FIG. 2b) in determining attributes in a proposed creative production (FIG. 2c). An iterative change between a preferred previsualisation (FIG. 2a) determined by an author and an expected previsualisation (FIG. 2b) determined by author and stakeholder occurs because of the exchange of standard contracts on the system. An author is the first user who sells a standard contract in a work on the system. A trader is any user who subsequently buys/sells a standard contract in a work on the system.

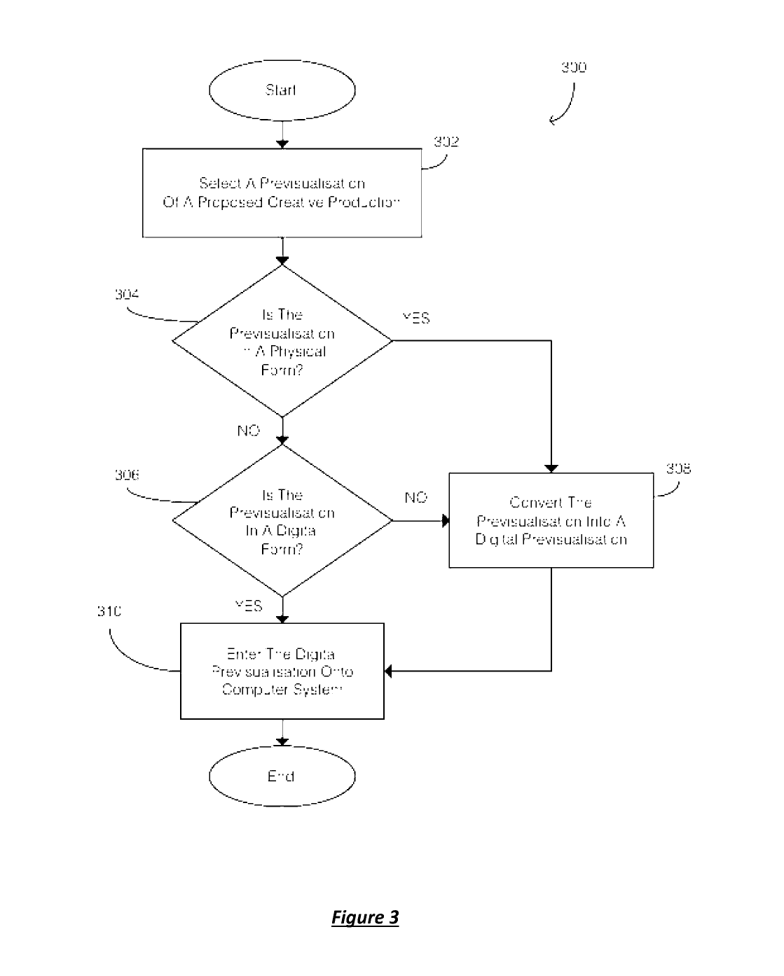

FIG. 3 discloses a method 300 by which a previsualisation may be entered into the system in the form of one or more digital media files. If necessary the selected previsualisation (302) is first converted into a digital media representation (304, 306, 308) before being stored in a database (310). The digital media files may be of any text, image, video, audio, software, book, or the like, in any digital format (e.g. TXT, JPEG, PDF, etc.). The digital media may be entered into the system from any keystation 108. Once entered, the computer system 102 maintains a database 114 of all digital media files representative of previsualisations against which are defined contracts available for trade, and the bids and offers that are present throughout the system for these contracts.

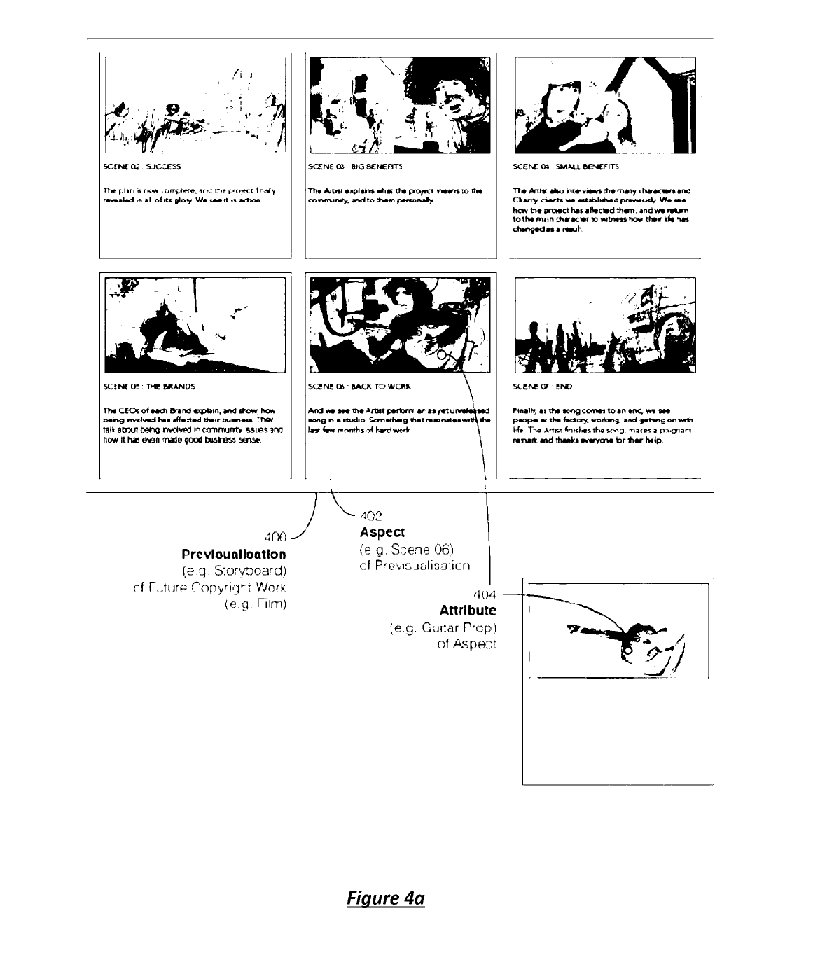

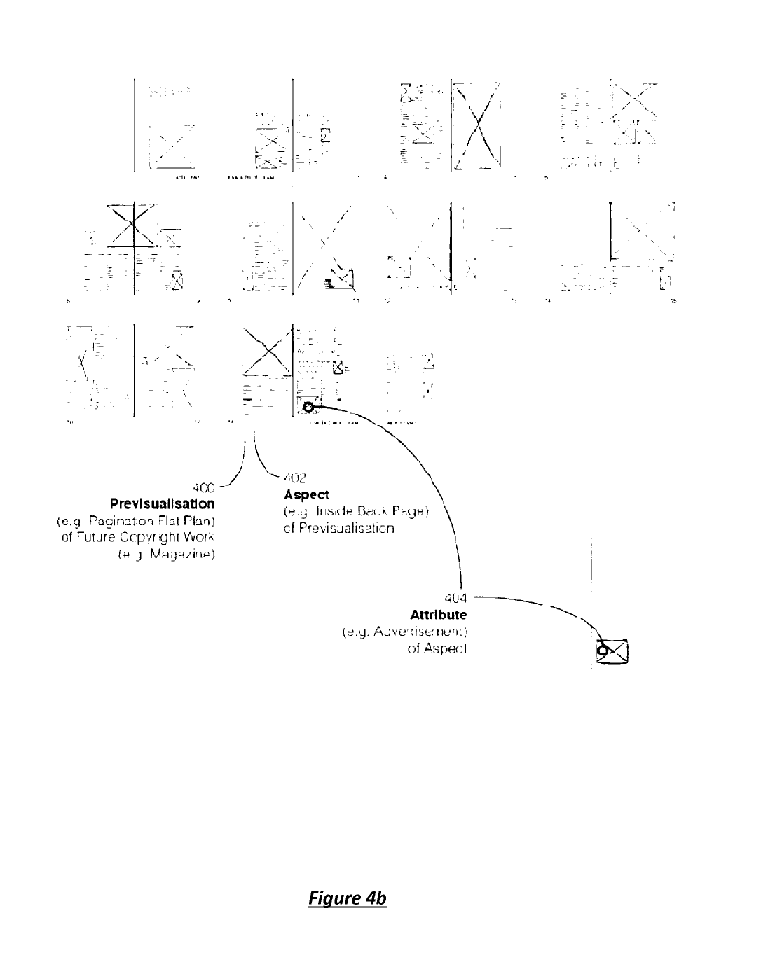

An exemplary embodiment of a previsualisation 400 is disclosed in FIG. 4; namely, a storyboard of a future film (FIG. 4a), and, a flat plan of a future magazine issue (FIG. 4b). Other forms of previsualisations for other proposed creative production may also be suitable. Once digital media is entered onto the system as a previsualisation, a user may choose a file and define a selection thereof as an aspect 402 of the previsualisation (e.g., scene 06 of film, inside back cover page of magazine, etc.). An aspect is a subset of the previsualisation. In this way a previsualisation can equal the sum of its aspects. Once an aspect is defined, a user may define some or all of one or more aspects by one or more attributes 404 (e.g. guitar prop in scene 06 of film, advertisement space on inside back cover page of magazine issue, etc.). An attribute is a subset of an aspect. Thus an aspect can equal the sum of its attributes.

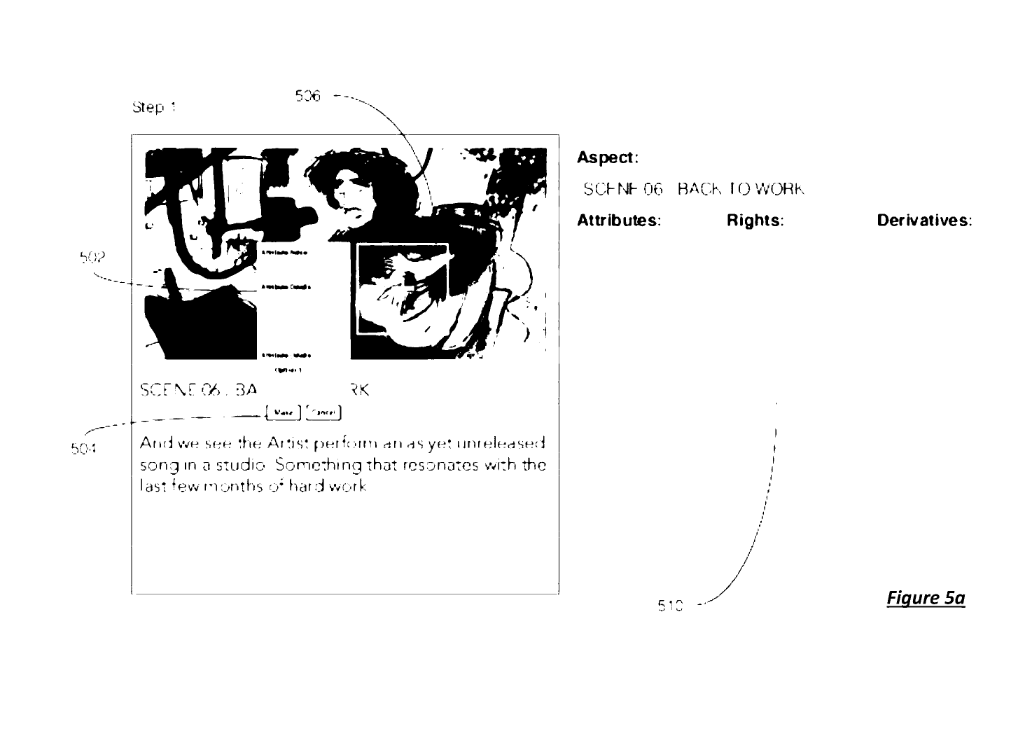

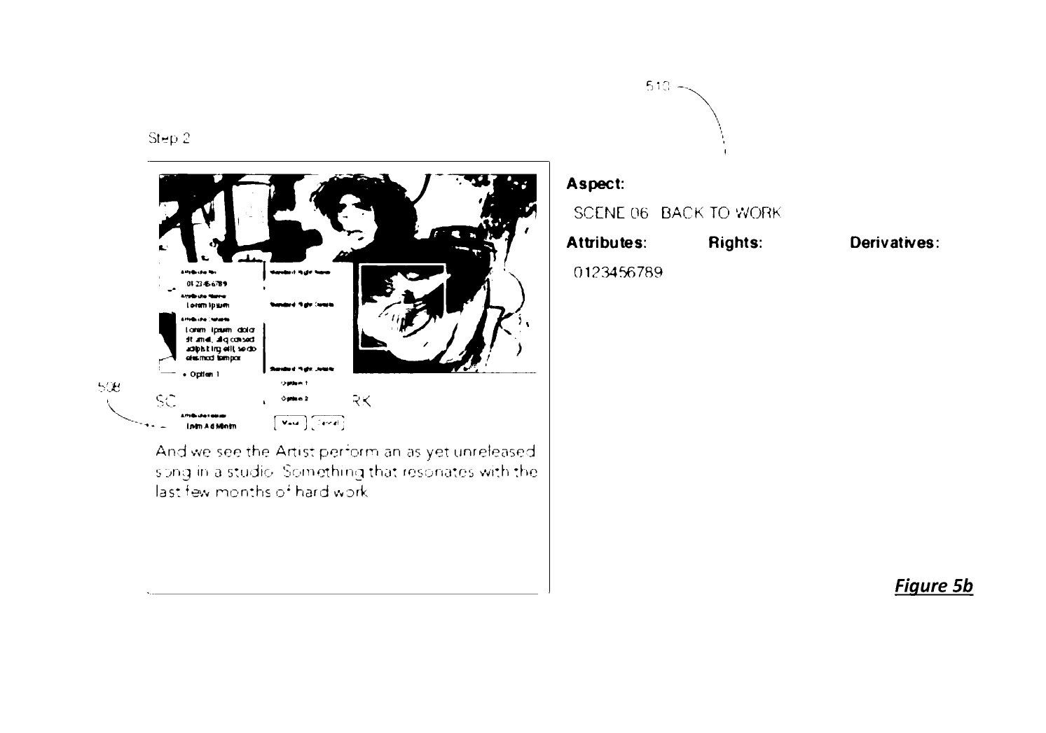

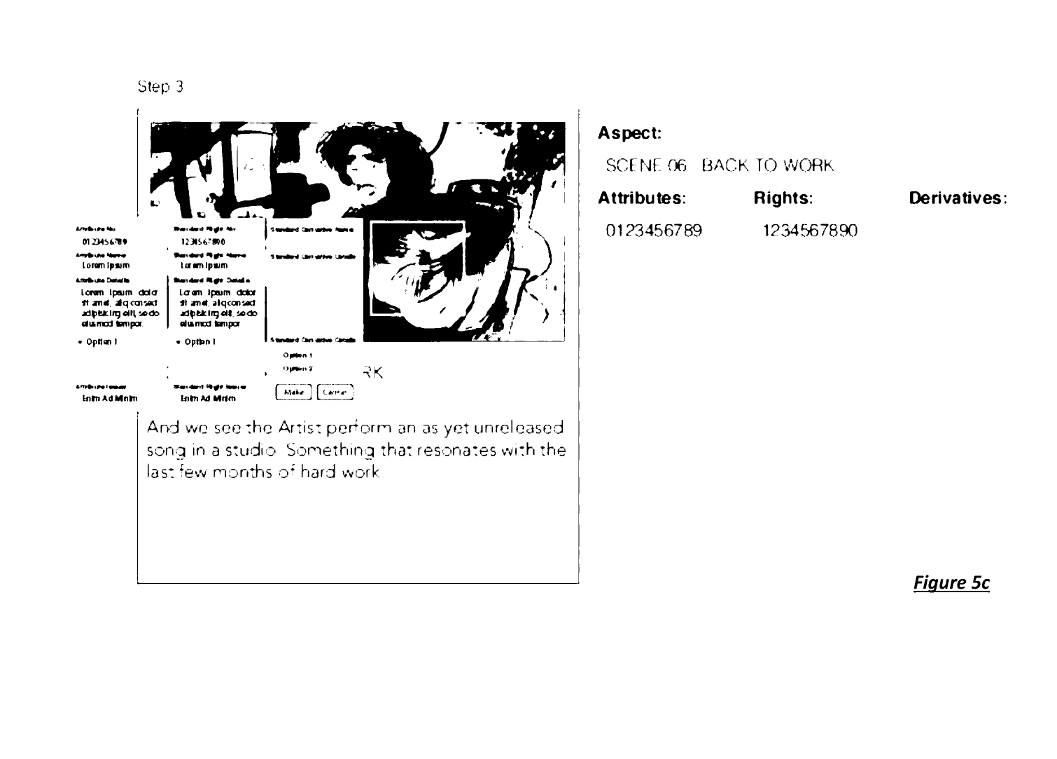

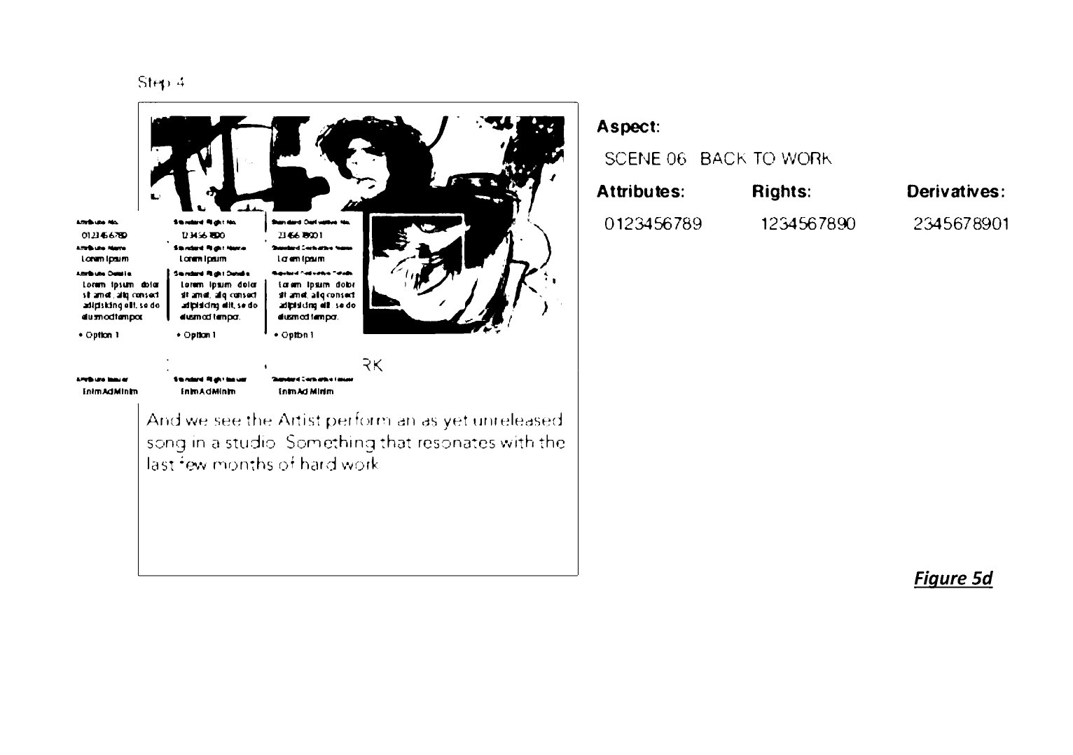

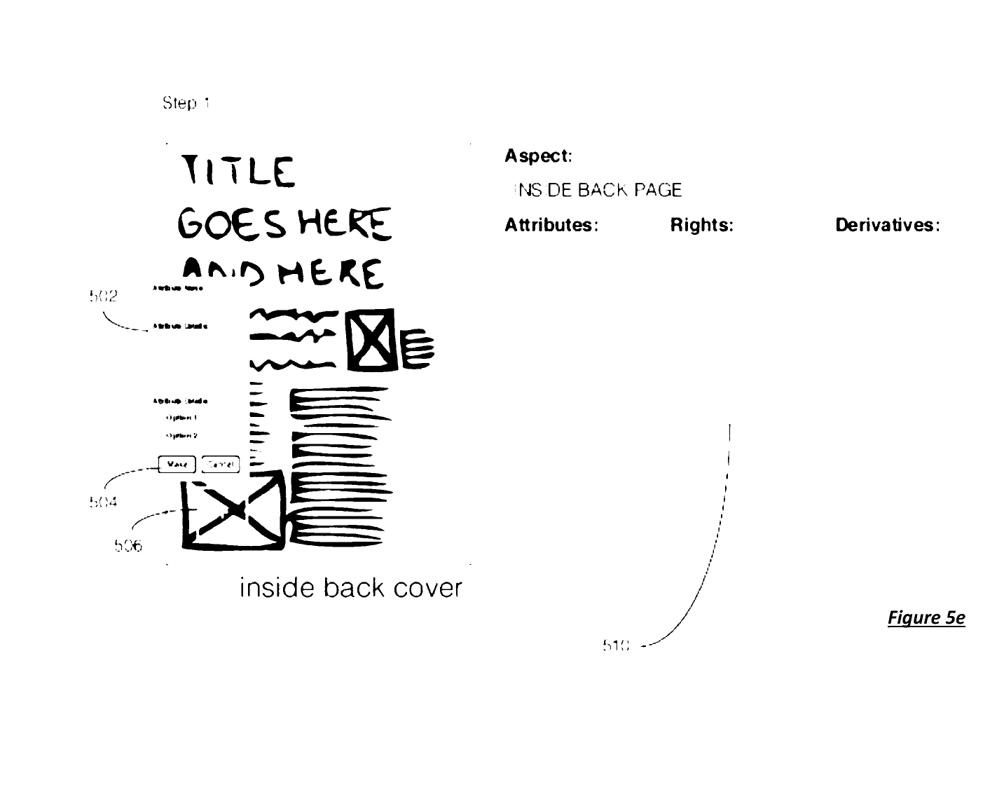

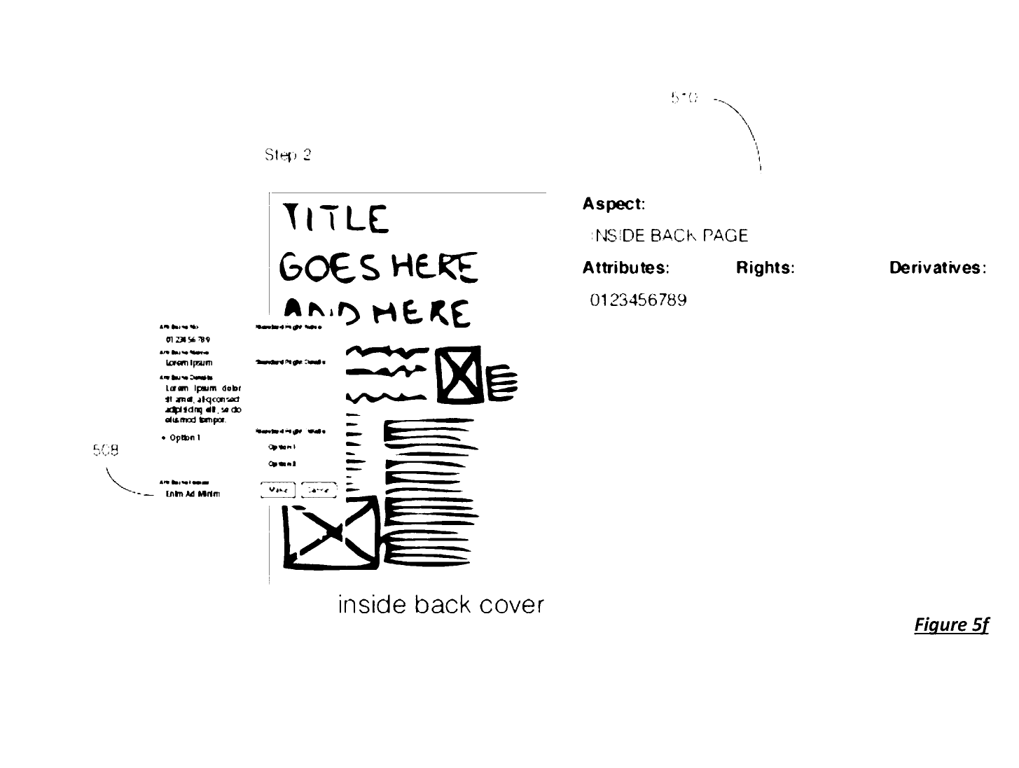

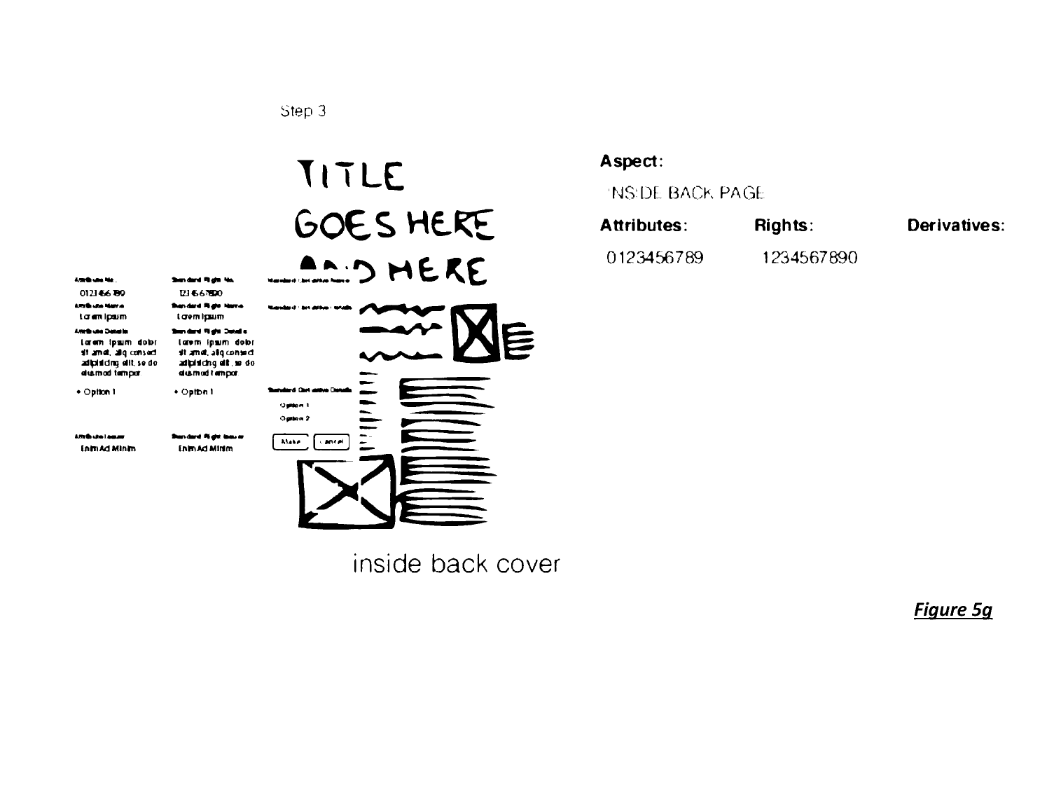

FIGS. 5a to 5h show, step-by-step, how a user can define an attribute of a previsualisation by selecting and tagging a region of an aspect. Specifically, it shows how in one embodiment, after having selected an aspect of a previsualisation, an adjustable border 506 may be superimposed over an aspect to indicate an attribute. This can be done by clicking a region of an aspect, defined on the system by a digital media file, in order to trigger a border and a properties dialogue box 502, as depicted by a graphical user interface (FIG. 5a).

In one embodiment, the properties dialogue box 502 may comprise a text entry field or a list of options. The user can specify attribute details into the properties dialogue box 502, for example, by typing text into a variable field or choosing from available options. Upon making 504 an attribute in this way, a summary certificate 508 may be generated of the typed text or selected options along with details such as, unique identifier, attribute details, maker details, and the like (FIG. 5b). Certificates can be made for aspects, attributes and standard contracts in this way, where a certificate may then embody specific and unique details of each.

In another embodiment, each certificate is added to, summarised and made visible in a certificate summary box 510, which comprises a list of some or all certificates. The certificate summary box 510 is a convenient expression of any certificates stored in a database 114. Details of each certificate or underlying previsualisation may be displayed by selecting an entry in a certificate summary box 510 (e.g., placing a cursor over an entry in the certificate summary box). Any member of the system may view details in this way via a keystation. FIGS. 5b, 5c and 5d illustrate this process for a film previsualisation, whilst FIGS. 5e to 5h show the case of a magazine previsualisation.

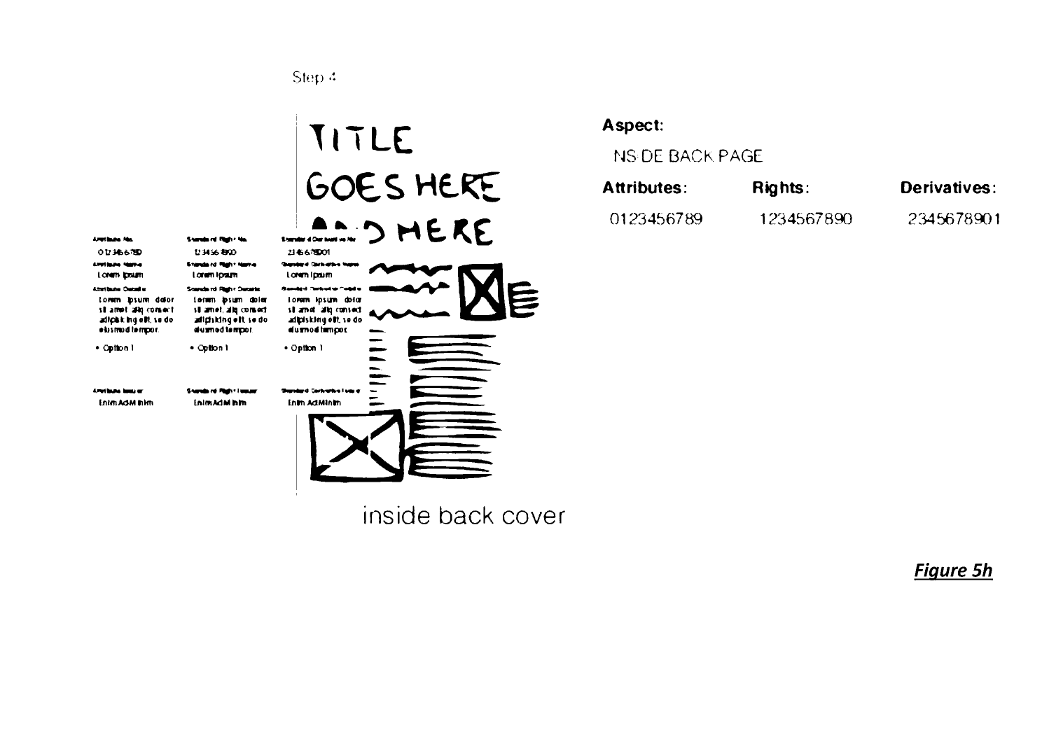

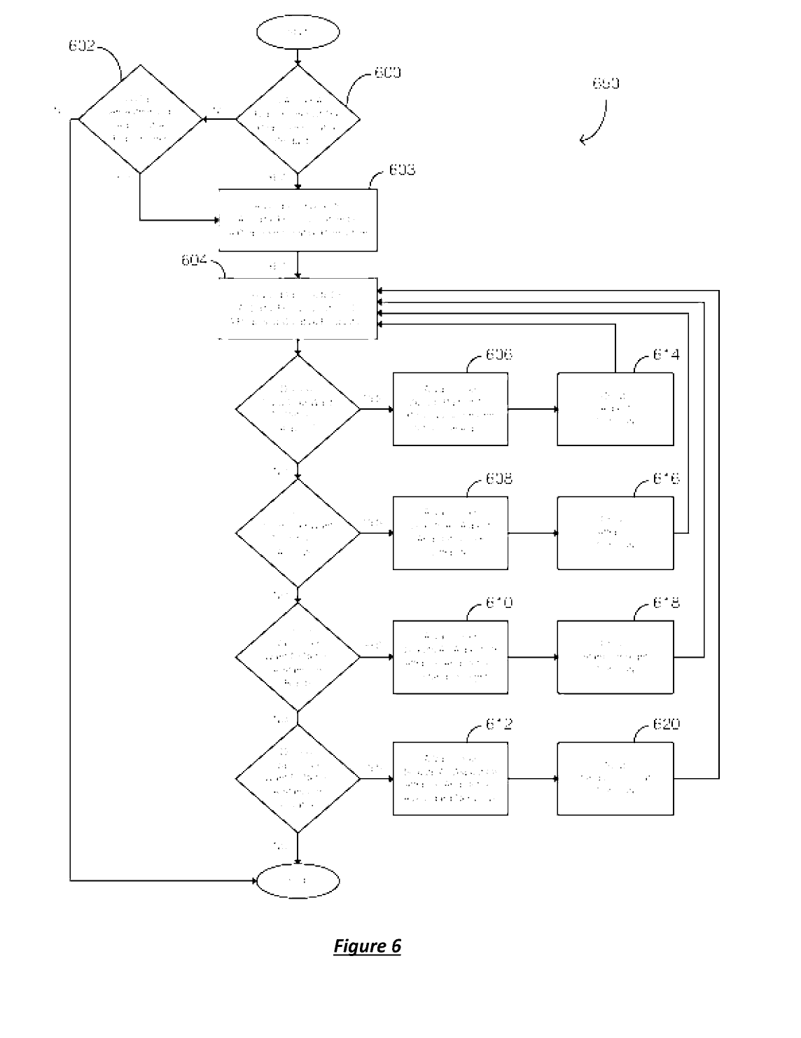

FIG. 6 is a flow chart diagram that illustrates a potential logic flow 650 by which one or more contracts may be defined against a previsualisation. Specifically, it shows how a rightsholder 600 or agent thereof 602 can use the digitally represented previsualisation 604 to define an aspect 606, an attribute 608, a standard right 610, and a standard derivative 612. In this way, one or more certificates can be generated for the defined aspect 614, attribute 616, standard right 618, or standard derivative 620 in each previsualisation.

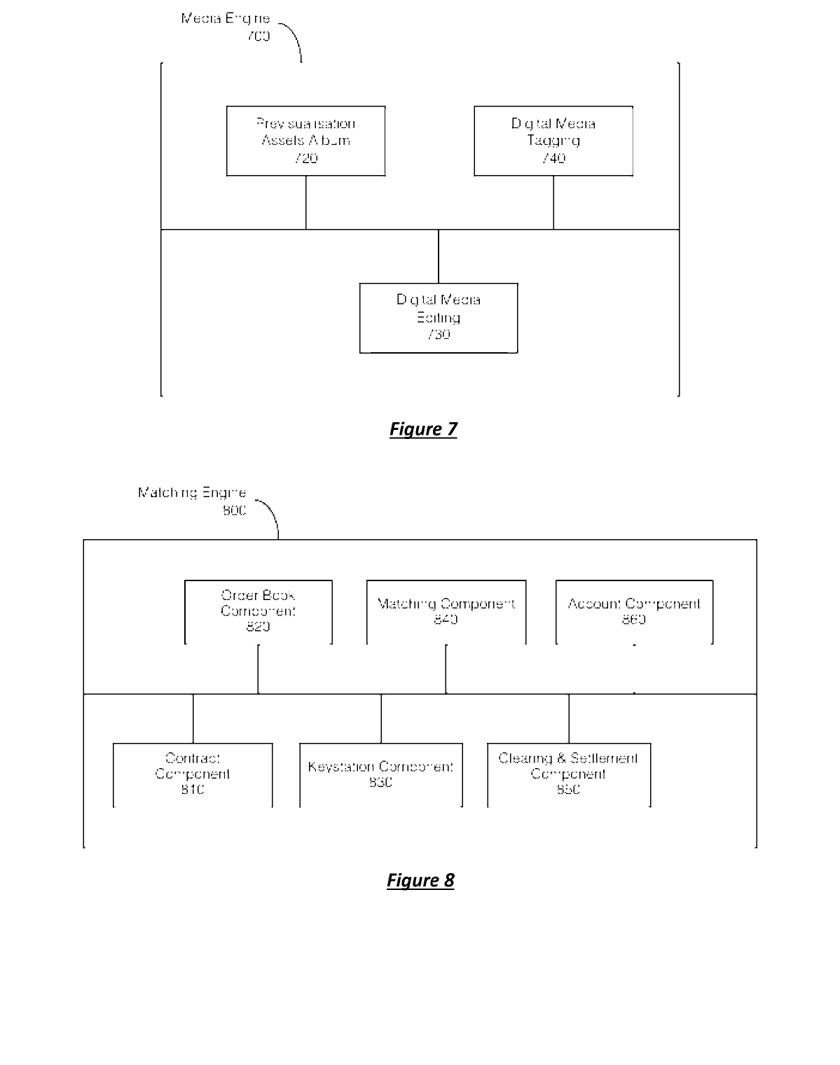

In order to make certificates from media, the system includes a media engine 700. FIG. 7 is a block diagram of an exemplary media engine, which is a computer-executable instruction module residing on the computer system 102 and is configured to provide a user with media services for manipulating digital media (e.g., images, text, video, and the like) on the system. The media engine includes a previsualisation assets album component 720, a digital media editing component 730, and a digital media tagging component 740. Although the media engine is described as being comprised of various components, fewer or more components may comprise the media engine and still fall within the scope of various embodiments. Examples of digital media manipulation include, without limit; creating a previsualisation assets album within a user account, uploading digital media files to the album, defining one or more digital media files as an aspect of a previsualisation, defining an attribute on one or more aspects of a previsualisation, defining a standard right against an attribute, or, defining a standard derivative against a standard right. Any aspect, attribute, standard right or standard derivative defined by the media engine is stored in a database 114.

The album component 720 is configured to create or delete albums. An album may be a collection of digital media files. Various embodiments of an album include a named folder containing digital media; a list of digital media files, and so on. Thus, in one embodiment, an album can comprise any number of elements that together can be called a previsualisation of a proposed creative production. In various embodiments, creating an album includes assigning a name to the album, recording details about the album, assigning access privileges for who can view or modify the contents of the album, and so on. The album component 720 can be further configured to display information about one or more albums. In some embodiments, this information can include album names; lists of albums; number of albums associated with a user; privilege information per album; number of digital media files per album; which album contains digital media that has been tagged either with an aspect, attribute, right or derivative; which album holds rights or derivatives that have all been sold, and similar.

The digital media edit component 730 is configured to modify any uploaded digital media so as to optimise the digital media in one or more albums for the benefit of the system and users.

The tagging component 740 facilitates region selection on digital media, certificate making and certificate display via a certificate summary box (e.g. 510 in FIG. 5). The tagging component may operate on any digital media uploaded onto the system. Although the tagging component is described as facilitating a set of functions, fewer or more functions may comprise the tagging component and still fall within the scope of various embodiments of the tagging component.

FIGS. 5a to 5h exemplify functionality of the tagging component 740 on different previsualisations. In one embodiment, working through a keystation, a user can use an input device 110 to move a cursor to a point in an aspect, click on that point and cause the tagging component 740 to place an adjustable border 506 around the selected region. The nature or size of the border may be fixed, automatically set or determined by the user. The tagging component 740 may work in an order such that an aspect must be defined first; an attribute defined second; a standard right defined third; and, a standard derivative defined fourth. The tagging component 740 may be configured to present a list of options into the properties dialogue box 502 for a user to select in making each certificate, as well as then generate and maintain a certificate summary box 510 once a certificate has been made.

To determine attributes in a proposed creative production, the system includes a matching module, or a matching engine, to match rightsholders and stakeholders around contracts to jointly determine the form and function of attributes. The matching engine helps an author/rightsholder facilitate extensive stakeholder engagement per attribute by helping them solicit expressions of interest from many prospective stakeholders; prioritise stakeholders based on bid value and choose stakeholders based on best bids. The matching engine makes it possible for an author/rightsholder to manage a large set of competing bids for an attribute and systematically rank bids using a market-based approach. In this way, the rightsholder optimises stakeholder selection as they work to determine the best attributes in a proposed creative production.

FIG. 8 is a block diagram of an exemplary matching engine 800, which is a computer-executable module on the computer system 102. The matching engine can provide a user with matching service to find a partner with whom to determine an attribute. Using proprietary logic, it does so by identifying a willing buyer and a willing seller of a contract. When specific criteria between buyer and seller are met such as, for example, when ask and bid prices align, a matching event is said to occur. When a matching event occurs, buyer and seller are informed and details are provided to each in order to complete a settlement.

The matching engine 800 needs functional support components to deliver its service. The matching engine has a contract component 810; an order book component 820 comprising an accumulation of ask and bid data present in the system listed against contracts and having a defined display depth range such as, for example, the best ask or bid, the next best ask or bid, and so on; a keystation component 830 used to update or display data on the computer system 102; a matching component 840 that automatically matches ask and bid listings in the order book for a given contract in time order entry; a clearing and settlement component 850 responsible for regulating the system, updating records and settling payments between users; and an account component 860. Although the matching engine is described as being made up of various components, fewer or more components may comprise the matching engine and still fall within the scope of various embodiments.

The matching engine 800 trades contracts between users by operating as a distributed exchanges system. It uses a configuration of the operating environment 100 that employs multiple keystations 108 interconnected via a network 116 with a computer system 102 and a database 114. Such a configuration is revealed in FIG. 1. The configuration is used to coordinate many users around a contract, automatically match users and effectuate an exchange between matched users. This method of coordinating users is more efficient than the current over-the-counter method of discovery and manual matching between parties.

The matching engine 800 maintains an order book 820 of bid and ask order entries against an inventory of contracts 810. A user of a keystation 830 interacts with the order book by submitting a bid or ask order by way of data entry into the keystation using an input device 110. The matching component 840 works to find matches between a new order and previous orders recorded in the order book for the same or similar contracts according to any market rules. If one or more matches are found then they may be reported back to some or all keystations. A trade can be executed for any matched orders subject to any market rules, like manual or automatic approval by the author. The clearing and settlement component 850 validates each order entry according to market rules and settles any transfer of funds between users accounts 860. Some or all keystations may be updated with some or all details of a settled trade. If a match cannot be found, the system disposes of the order entry or keeps the entry for later processing, subject to market rules, in which case details of an unmatched order may be disseminated to one or more keystations. Preferably in all cases, orders are processed to completion until matched according to market rules.

Copies of some or all orders in the order book 820 are maintained by the keystation component 830 to generate a graphical display for one or more users. Any keystation can have visibility into the order book 820. At all times a keystation 830 can display a depth of data showing at least the best price for a given contract listed on the system. The best price may be defined as the lowest ask value to sell a contract or the highest bid value to buy an contract. Prices are displayed together with any pertinent details so a user of a keystation can observe market activity and decide whether to enter a counter order into the market in an attempt to execute a trade. A bid or ask order from one user may be visible to another user who has or has not made a counter order for the same or similar contract.

The matching component 840 can make a match between a buyer and seller based on the collection of bid and ask orders it can see in the order book 820. The matching component 840 creates a matching event between one or more bid orders and one or more ask orders using market rules such as, for example; orders are matched if their values fall within a defined range of one another, equal one another or the highest bid is greater than the lowest ask; orders are matched such that older entries are matched before newer orders; or, orders are matched such that a user with a better credit rating is matched before a user with a poorer credit rating. Once bid and ask orders are matched, an exchange can be executed between matched orders manually or automatically. A manual execution happens if a seller of a contract accepts a bid order matched to it or a buyer of an contract accepts an ask order matched to it. A user is free to deviate from a recommended best match and choose any matched order based on personal criteria. An automatic execution happens if a user programs their criteria for accepting a match into the system. If the best match satisfies the programmed criteria then a match can be automatically executed.

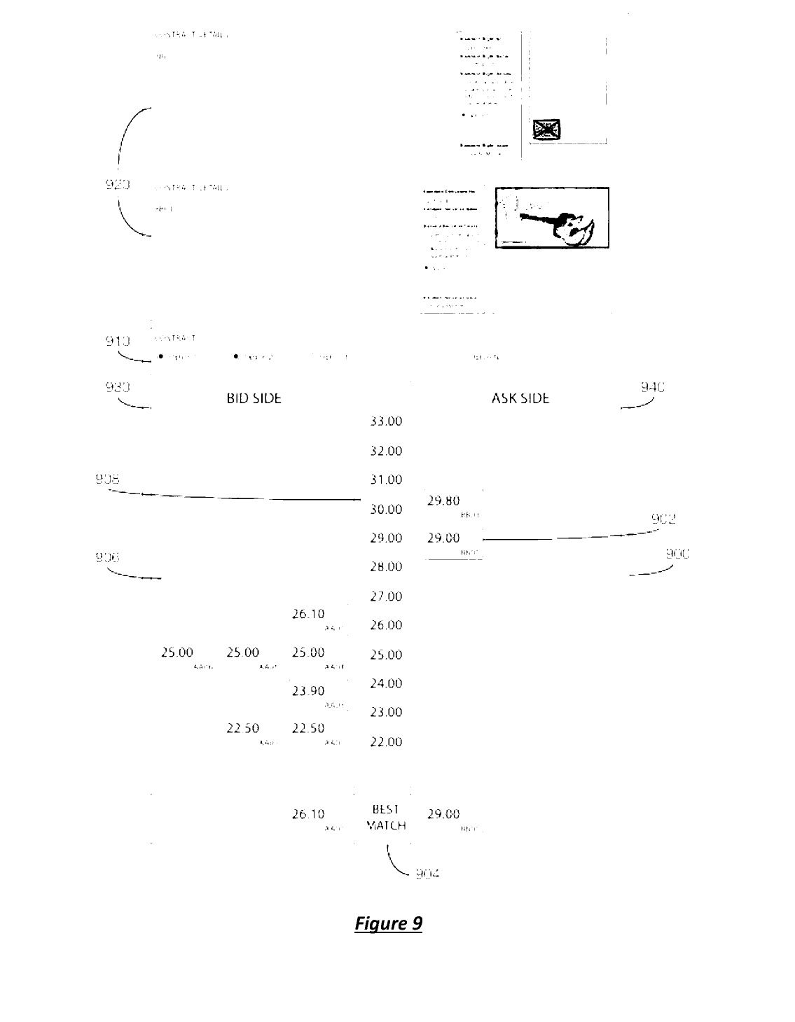

The order book 820 for a given contract may be configured and displayed in any manner through a keystation 830 so as to present bid and ask orders to users. Without limit, FIG. 9 shows one configuration where part of an order book 820 is presented by a keystation 830 via a graphical user interface 900, which may be divided into a bid 930 and ask 940 side. The bid side may comprise all orders to buy one or more contracts 920 and the ask side may comprise all orders to sell one or more contracts 920. Sides may be ascribed around a vertical value column 908 such that bid orders are set on the left and ask orders are set on the right. The sum of orders on both sides equals the market, or an order book, for one or more contracts. Separate markets may be maintained for each contract.

An order box 902 depicts an order in the market. The value of the order displays in the upper left corner of the order box. Additional details may be displayed in the lower right corner of the order box such as, for example, user details, time-to-expiry, and so on. Orders may be in any units of value such as dollar, discount, and so on. A user can enter an order onto the order book via a keystation 830 by following, for example, process 1000 illustrated in flow chart diagram form in FIG. 10.

The keystation component 830 lets a user find a preferred contract against which to place an order by providing an interactive search dialogue box 910 with search options in the keystation graphic user interface 900. A user who wants to submit a buy order uses the search dialogue box to make a query on all contracts in the order book. If the query returns a contract then the user can record a buy order against the contract onto the order book. Similarly, if a user wants to sell a contract then the user needs to identify an contract upon which to place a sell order. To identify a contract to sell, the user either selects a contract from their user account 860 or makes a query on their user account 860 to find a suitable contract. The user can subsequently record a sell order onto the order book against a contract in their account.

The search dialogue box 910 may contain one or more criteria that a user can select to define a contract against which to place an order. Once a user has defined the desired criteria of a contract, they instruct the matching engine to perform a search of recorded contracts. Criteria set into the search dialogue box can be based on anything, such as criteria required of the work, like for example; audience profile (e.g. work is suited to a 19-27 year old female target audience); geographical region of publication/distribution (e.g. work is scheduled to be published or distributed in Australia); specific channel by which the work may be published/distributed (e.g. Internet, print, etc.); specific period of time within which the work may be published/distributed (e.g. 1-15 Sep. 2016), and similar. Search results 920 show details of certificates and previsualisations recorded onto the system that satisfy the specific criteria entered into the search dialogue box 910. Search results 920 are portrayed via the keystation graphic user interface 900 to a user and made ready for the user to record an order against. The user may record an order against any contract returned from such a query.

The overall distributed matching system operates under a concept where a keystation 830 may be either an originating keystation or counterparty keystation depending on the nature of the transaction. In this way, a user may be both an originator or counterparty for different transactions. Accordingly, a keystation may be an originating keystation in one instance and a counterparty keystation in another instance. There may be instances in which a keystation is a bystander and not involved in a transaction.

Control of the overall distributed matching system is maintained by a computer system 102, which operates according to a set of rules that govern how orders are processed.

The computer system 102 processes orders against a particular contract in time order of entry. The behaviour of a recorded order is similar to an auction market in that when an entry is worse than the current best entry it is either rejected from the market or delegated below the best entry in the market. When an entry equals the current best entry, it is accepted into the market and positioned as the last entry in time order. When an entry is better than the existing value for the side of a market, the current entries in that side of the book are either cancelled or relegated to inferior positions in the market. How an entry behaves is subject to the market rules by which the computer system 102 operates. Once an order is placed into the order book, matching is attempted when the best bid value is better than, equal to or within a range of the best ask value. If one or more matches are found, the following details may be given for each matching pair; namely, buyer, seller, contract and quote in either the order box 902, or elsewhere. A summary of the best match 904 may be displayed in a keystation graphic user interface 900.

Each keystations needs information to generate a display. Preferably, displays are as up to date as possible so that traders are provided with accurate information regarding contracts. A computer system 102 may distribute information from one or more order books for one or more contracts among distributed keystations through the use of summary order books in a manner whereby the summary order books may comprise a subset of information from the order books in an attempt to improve the efficiency of technical data transfer.

FIG. 1 shows that any keystation 108a can originate a transaction and any keystation 108b can be counterparty to a transaction. Therefore, at any point in time, there may be more than one originating or counterparty keystation at more than one location involved in a transaction. Originating keystations 108a and counterparty keystations 108b may be remotely located from each other such that, for example, an originating keystation 108a can be in Sydney, Australia, and a counterparty keystation 108b can be in Melbourne, Australia. In addition, keystations (108a, 108b) may be remotely located from the computer system 102, which for example may be in Brisbane, Australia.

The message flow of a transaction may follow any protocol determined by the market rules. As an example, in one protocol, a keystation 108a may generate a display of a summary order book for a contract from an order book located on the computer system 102. If the user at that keystation 108a desires to originate and enter a bid or ask order, this information may be input to the keystation 108a via any input device 110, such as a keyboard. Preferably, the order is then validated and updated in the keystation 108a local summary order book. After the order has been entered, validated, and, the local summary order book on the keystation 108a updated, a transaction message made of order information is built and sent to the computer system 102. Upon receipt, the transaction message is time stamped by the computer system 102. Once the transaction message is received and time stamped, the computer system 102 then sends an acknowledgment message back to the keystation 108a informing it the transaction message has been received. The keystation 108a display may read ‘processing’, or similar, until a transaction message has been acknowledged. The transaction message is then preferably processed by the computer system 102 against the order book contained in the database 114 for the contract in question.

Once an acknowledged order is processed and added onto the order book, that entry may be matched against existing bid or ask orders contained in the order book database 114. Once any processing is completed, the computer system 102 may generate an output message which is sent back to the originating keystation 108a and potentially any other keystation in the distributed network, such as a counterparty keystation 108b. The output message may deliver any information, such as a list of one or more matched orders, which can be displayed on the originating keystation 108a or counterparty keystation 108b. A single transaction message from a keystation, whether it is a bid or ask, could result in none, one or multiple matches. If a match occurs, it may be displayed on the screen of the originating keystation 108a or counterparty keystation 108b in order from best to worst. The user is then free to select the best matched order and either accept or reject it, subject to any market rules.

Best and worst orders are relative. On the bid side 930, the ‘best’ order box with the highest value is ranked at the top of the stack of all order boxes matched with an ask order, such that all order boxes below it represent bid orders with lower values. On the ask side 940, the ‘best’ order box with the lowest value is ranked at the bottom of the stack of all order boxes matched with the bid order, such that all order boxes above it represent ask orders with higher values. Thus, both bid and ask order boxes are sorted by value, with values descending from highest at the top to the lowest at the bottom.

As shown in FIG. 9, the time entry of orders in the order book radiates outward from the value column 908. If the bid side 930 is on the left and the ask side 940 is on the right, then on the bid side 930 the oldest order is right most and closest to the column while the newest order is left and furthermost from the column. Similarly, on the ask side 940 the oldest order is left most and closest to the column while the newest order is right and furthermost from the column. In this way, the ‘best’ order on the bid side is ranked at the top of the stack and closest to the column while the ‘worst’ order on the bid side is ranked at the bottom and furthermost from the column. Similarly, the ‘best’ order on the ask side is ranked at the bottom of the stack and closest the column while the ‘worst’ order on the ask side is at the top and furthermost from the column. Based on the market rules, it may be possible that there is a value spread 906 between the best bid order and the best ask order.

An author may sell a contract using the described system by recording a sell order onto the order book as part of an initial public offering. In doing so the author may use any number of techniques to solicit the best offers such as, for example, an auction technique whereby they withhold the preferred ask value while concurrently soliciting bid offers from users in order to expose the maximum value a prospective buyer is willing to offer. Alternatively, a holder of a contract may attempt to sell a contract by recording a sell order onto the order book and revealing a preferred ask value while concurrently soliciting bids.

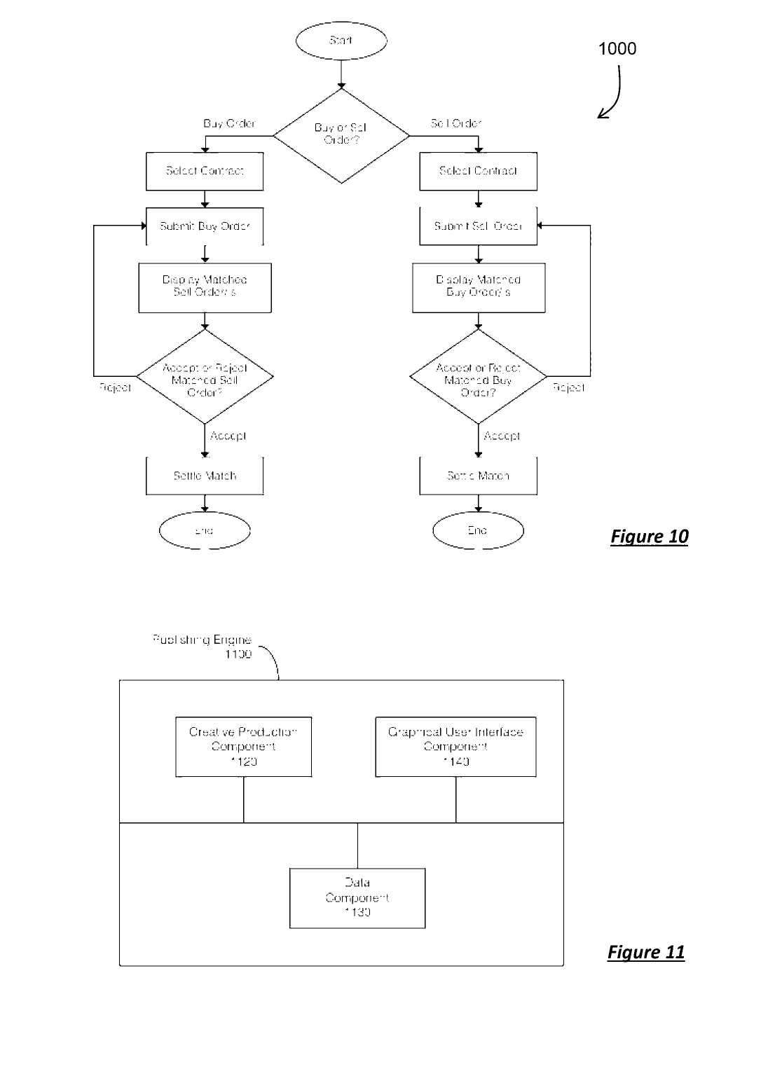

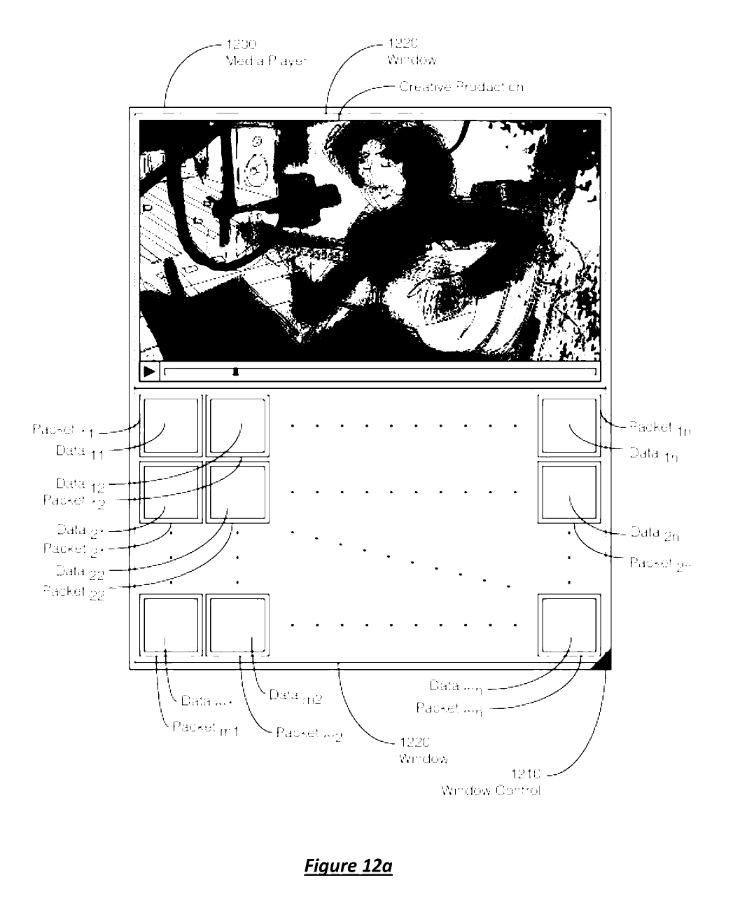

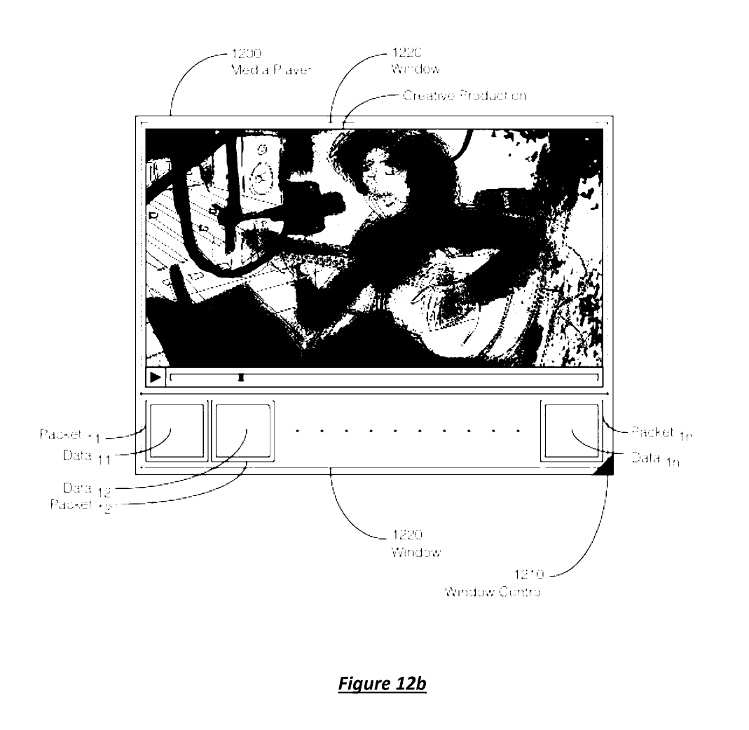

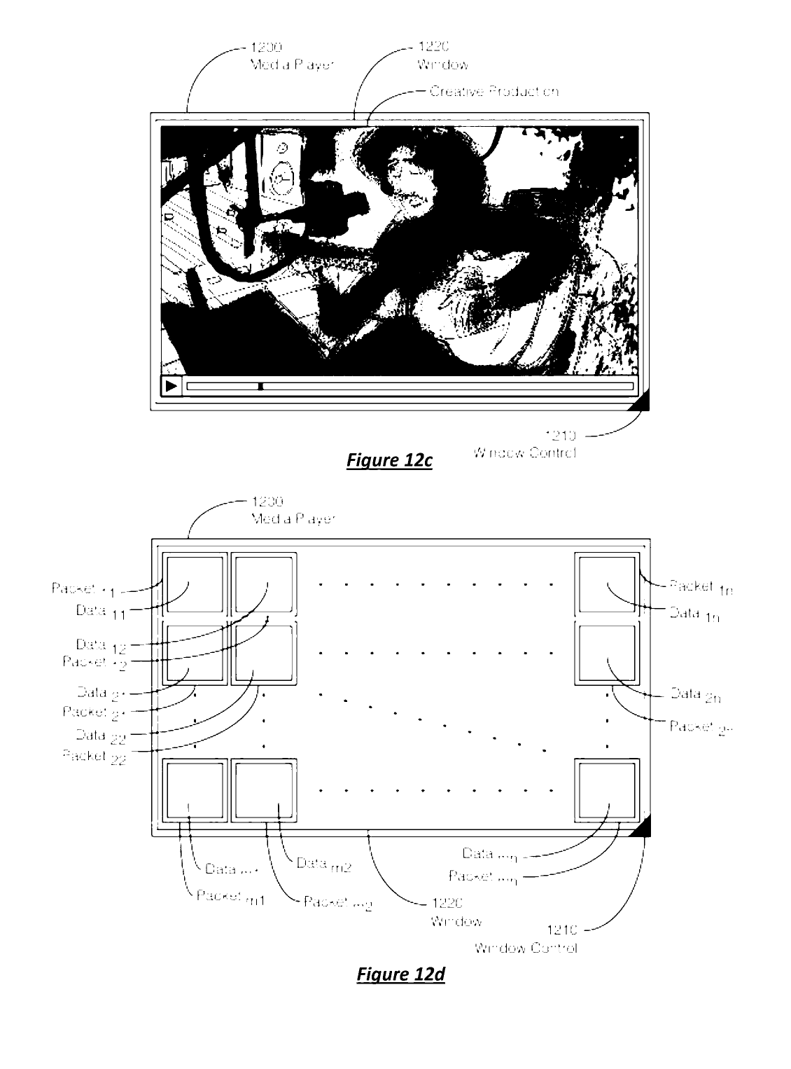

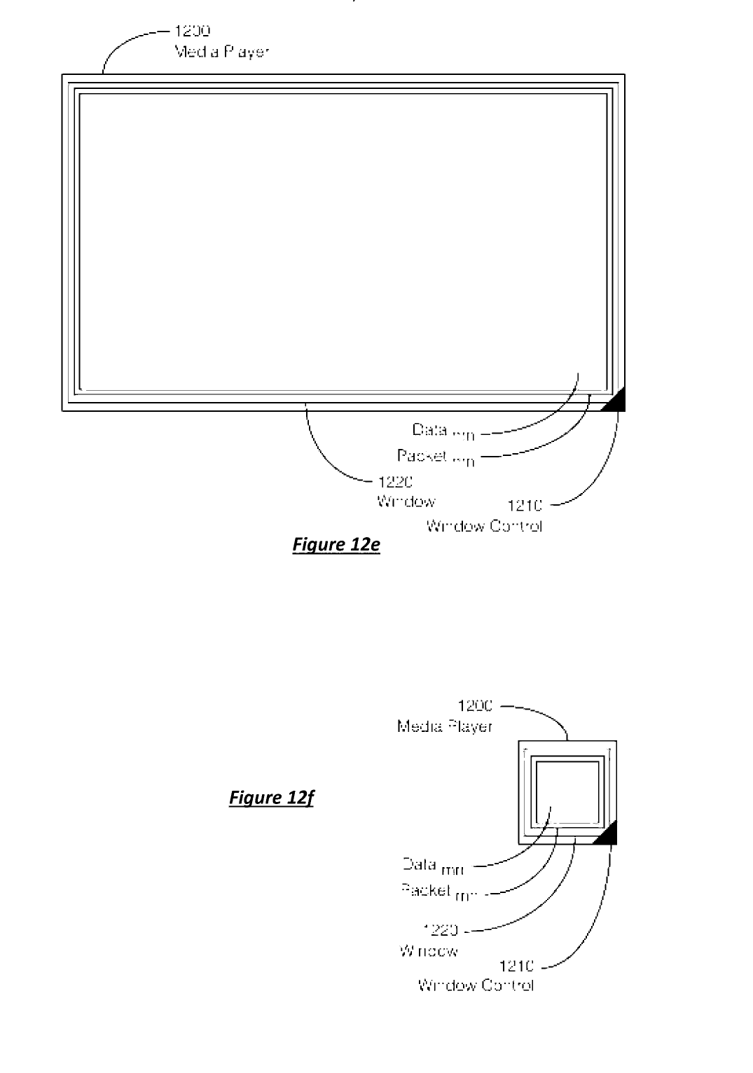

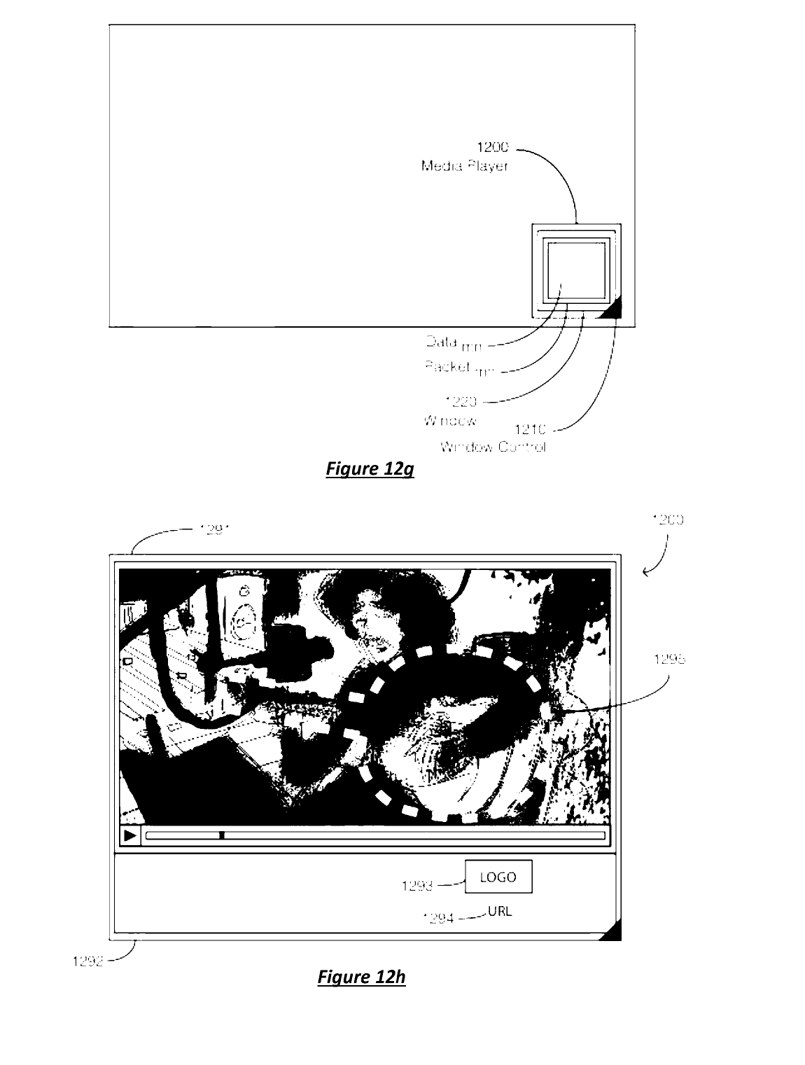

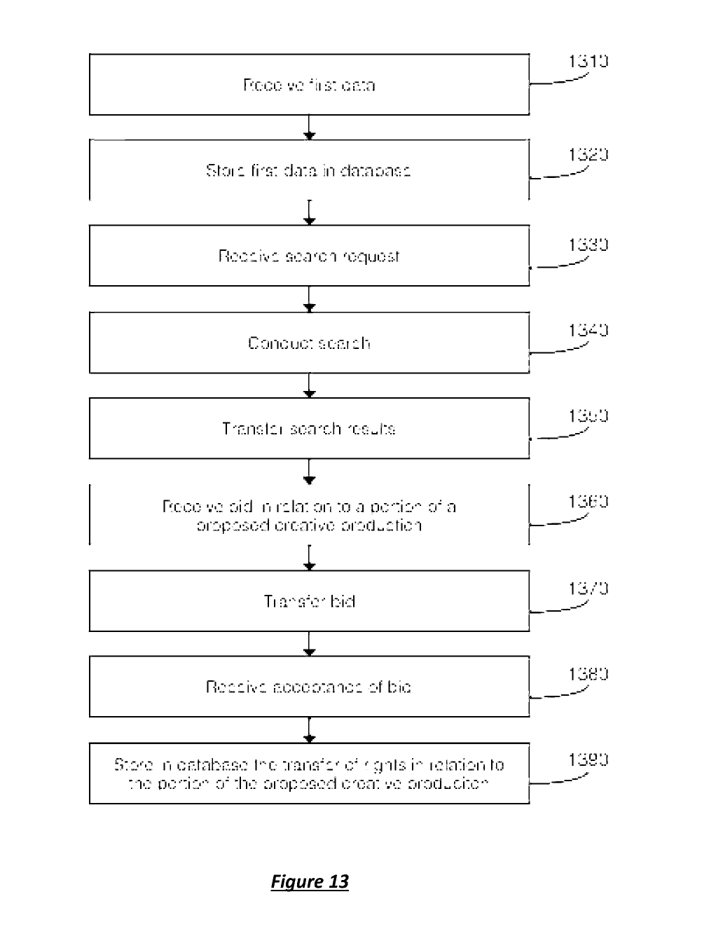

Once attributes have been determined in accordance with the present system, the creative production may be fixed in a medium via a publishing module, or publishing engine 1100 to meet any of various purposes, such as commercial exploitation. The publishing engine 1100 is a computer-executable instruction module residing on a computer system 102. FIG. 11 shows an exemplary publishing engine using machine-readable instruction to fix work into a medium, such as an output device 110, via Internet protocol television (IPTV) technology, over-the-top (OTT) technology, or similar. Such a publishing engine may include a media player having features as described hereinbelow with reference to FIGS. 12a to 12f, where the work may be parsed into multiple windows depending upon any number of parameters. Thus, for example, in one embodiment a window may publish a part of the work by serving a lossy audio/video file from a server (FIG. 12c). In another embodiment, a window may publish a work by serving a plurality of packets (Packet₁₁, . . . , Packetₘₙ) (FIG. 12d) or a single packet (Packetₘₙ) (FIG. 12e, 120, along with data served into each packet. Each data and packet combination may be served simultaneously (FIG. 12a, 12b) or alternatively with a window that publishes another part of the work, for example a lossy audio/video file.

The publishing engine 1100 needs functional support components to deliver its service. As such, the publishing engine includes a proposed creative production component 1120, a data component 1130, and a graphical user interface component 1140. Although the publishing engine is described as being comprised of various components, fewer or more components may comprise the media engine and still fall within the scope of various embodiments.

A user can interact with a work which may be expressed as an electronic object or data component such as, for example; a lossy audio/video file; data within an electronic packet, or similar, served from a database 114 by a computer system 102 and displayed via the graphic user interface component 1140 that determines how one or more windows 1220 is rendered via an output device 110. Windows may be regulated by a control 1210 in the graphical user interface component 1140 such that any window may be displayed in any manner. Packets in a window may be embodied in any configuration and in any size (FIG. 12d, FIG. 12e, FIG. 12f). Packets may appear independently (FIG. 12e, FIG. 12f) or concurrently (FIG. 12d) with other packets. They may appear synchronously or asynchronously with respect to attributes of a work in other windows (FIG. 12a, FIG. 12b).

Work may be served into a media player 1200 from a work component 1120 and a data component 1130. The media player can be used to coordinate attributes of the work with data such that data served into a packet from a database 114 may be static, dynamic or interactive and include, for example, computer-executable instruction, video, audio data, graphic, text, or similar. This data may be in any format such as, for example, computer-executable code (e.g. Flash, JavaScript, etc), lossy video/audio file (e.g. MPEG, WAV, etc), image file (e.g. JPEG, GIF, etc), text file (e.g. TXT, RTF, etc), or similar. Data may render in a packet by use of any known or yet to be developed computer-executable programming protocol, standard or language such as, for example; C++, JavaScript, Perl, Python, Ruby, PHP, HTML, or similar. Static data may be regarded as not performing any action on a work. Dynamic data may be regarded as performing an action on a work, to the extent of being used to control a work or an attribute of a work. Interactive data may be regarded as performing any action independent of a work, such as an action on a hyperlinked document such as a web page.

Without limit, a right to serve an electronic object or data component from a database into a packet associated with a published creative production, as mediated on the media player 1200, may also be traded on the system in a similar manner to that of a contract.

The media player 1200 may be embedded into any software package, framework, hardware platform, computer system, mobile application, operating system or any similar platform, by any means; including manually via a software development kit and the implementation of one or more application programming interfaces with a programming language, or automatically by an action such as, for example, a social media sharing action. In this way, a creative production may be embedded in, for example, a website as shown in FIG. 12g, or any other content such as a mobile app, TV app, or similarly elsewhere on any output device 110 such as a smart phone, computer tablet, personal computer, smart television, IPTV player, OTT technology, or similar, by any means. In this way, attributes of a creative production can be made discoverable wherever a work is published.

Referring to FIG. 12h there is shown an interface of a media player 1200. In particular, the interface of the media player 1200 can include a first portion 1291 and a second portion 1292. The first portion 1291 presents the digital moving visual work. The second portion 1292 is configured to present one or more digital objects 1293, 1294 related to the bidding party (herein the rightsholder) who owns a right to at least a portion of the digital moving visual work. When the one or more portions of the digital moving visual work associated with one of the rightsholders is visible during playback of the digital moving visual work, one or more digital objects 1293, 1294 associated with the respective party is presented within the second portion 1292 of the interface of media player 1200.

In one form, the media player is a computer program that is stored in memory accessible by the server processing system or another processing system which hosts the moving visual work. A code fragment, for example a JavaScript code fragment, can be incorporated into code defining a webpage, wherein the webpage can be viewed by a viewing processing system, in communication with the server processing system via a network such as the Internet, via a web browser, or the like. Interpretation or execution of the JavaScript code fragment of the webpage results in communication with the server processing system having access to the media player computer program. As a result, data is transferred back to the viewing processing system indicative of the interface of the media player. The interface of the media player can be presented within a frame of the webpage.

The data received from the server processing system can include the digital moving visual data, which can be streamed from the server processing system, and rights data indicative of the one or more parties who own one or more rights to at least a portion of the work associated with the digital moving visual data. The rights data may be streamed, although it is possible that all the rights data is received in a single data block or transferred intermittently in a plurality of portions when required based on the progress of the playback. The rights data can be metadata of data indicative of the digital moving visual work.

The rights data can be indicative of one or more rightsholders associated with one or more portions of the digital moving visual work and one or more time periods of the digital moving visual work which are owned by the rightsholders. For example, the rights data may indicate that for a time period extending between 1:06 minutes to 2:04 minutes that a guitar played by an actor was provided by the rightsholder which is visible within the first portion 1291 of the media player interface 1200 presenting the playback of the digital moving visual work. As a result, one or more digital objects 1293, 1294 associated with the rightsholder who provided the guitar is presented within the second portion of the media player. It will be appreciated that as the playback of the digital moving visual work continues, the one or more digital objects 1293, 1294 which are presented within the second portion of the media player interface 1200 change based on the various rights owned by various rightsholders. Thus, the presentation of the one or more digital objects 1293, 1294 within the second portion of the media player interface 1200 are synchronised according to particular time periods of the playback of the digital moving visual work. Once a time period has elapsed for a rightsholder, the one or more digital objects 1293, 1294 may no longer be visually presented within the second portion 1292 of the interface 1200.

The one or more digital objects may be a logo, a picture, a text, an animation, an executable script or program, a URL embodied as a hyperlink, or any of the like, which is associated with the rightsholder of a portion of the digital moving visual work. More specifically, in relation to the above example, when a bidding party secures the rights to a portion of a digital moving visual work and thus becomes a rightsholder, data indicative of the one or more digital objects may be uploaded and stored in the database by the server processing system. When the digital moving visual work is being completed, or fixed in a medium, the data stored in the database associated with the digital object can then be used by the server processing system to provide this functionality.

In the event that the rights data is indicative of a URL associated with the rightsholder, the second portion 1292 of the media player 1200 can include one or more hyperlinks 1294 or interactive portions 1293 presented within the second portion 1292 of the media player 1200 which can be selected by a viewing user of the viewing processing system using an input device of the viewing processing system. As a result of the selection, a new window or tab can be opened by the web-browser presenting a webpage associated with the URL. For example, continuing with the guitar example above, the selection of the corresponding interactive portion 1293 of the second panel associated with the rightsholder who provided the guitar can result in a webpage being presented to the viewing user that allows the viewing user to order and purchase the guitar.

In a further variation, the data received by the viewing processing system from the server processing system can additionally include boundary data indicative of a boundary 1295 of a portion of the digital moving visual work associated with the rights owned by the one or more rightsholders. Similar to above for the rights data, the boundary data may be received in a single block or alternatively in a plurality of portions when required based on current playback of the digital moving visual work. Continuing with the guitar example above, the boundary data can define a physical space that substantially defines a boundary 1295 around the guitar being played by the actor during the playback of the digital moving visual work. It will be appreciated that whilst the boundary 1295 shown in FIG. 12h is visible, this is merely for clarity and generally the viewing user would not be able to view the boundary 1295. The viewing processing system is configured by the data received from the server processing system to detect when an input device of the viewing processing system selects or interacts with the area within the boundary 1295 defined by the boundary data. For example, the viewing user may move the cursor associated with the mouse device over the area near the guitar. In response, the viewing processing system is configured to perform an action associated with the rightsholder. For example, the digital object 1293, 1294 presented within the second portion 1292 associated with the respective rightsholder may be highlighted within the second portion 1292 of the interface of the media player 1200. Additionally, in the event that the user selects the area of the digital moving visual work defined within the boundary 1295 of the boundary data, the viewing processing system may execute the same action which is associated with selecting the digital object presented within the second portion 1292 of the media player 1200. For example, should the viewing user move the cursor within the area defined by the boundary 1295 associated with the guitar being played by the actor, the respective digital object within the second portion 1292 of the media player 1200 may be highlighted in response, and then if the viewing user selects (for example, by clicking with a mouse device or tapping with a finger upon the guitar) an area within the boundary 1295, a new window or tab opens within a web browser showing a webpage associated with the rightsholder. For example, a webpage allowing the viewing user to purchase the guitar being played by the actor may be presented in response to selecting an area within the defined boundary of the first portion of the media player interface 1200. It will be appreciated that the boundary may not perfectly surround the respective object within the visual presentation of the digital moving visual work, however there will at least be some overlap of the area defined by the boundary 1295 and the object. It will be appreciated that the boundary for a rightsholder can move during the playback of the digital moving visual work (for example, the actor may move during the digital moving visual work and thus the boundary would move accordingly). The boundary data can include spatial attributes such as physical coordinates defining the boundary within the first portion of the media player and temporal attributes defining a time period that the boundary is to be present for the area defined by the spatial attributes.

It will be appreciated that more than one set of digital objects can be presented within the second portion of the media player 1292 in the event that more than one rightsholder owns a portion of the digital moving visual work which are presented simultaneously. For example, continuing with the example of FIG. 12h, a boundary may be defined around a microphone that is also simultaneously with the guitar displayed within the digital moving visual work.

Many modifications will be apparent to those skilled in the art without departing from the scope of the contemplated embodiments.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### Following Sections I-VII Provide a Guide to Interpreting the Present Specification

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted or transmitted according to numerous formats, standards or protocols, such as Ethernet (or IEEE 802.3), SAP, ATP, Bluetooth™, TCP/IP, TDMA, CDMA, 3G, internet protocol suite, mobile services or networks used for telecommunication that comply with any specifications set by the International Telecommunication Union, such as the International Mobile Telecommunications-2000 (IMT-2000) specification; or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial online service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may be performed by or stored on one or more such devices.

Where a process is described, in an embodiment the process may operate without any user intervention. In another embodiment, the process includes some human intervention (e.g., a step is performed by or with the assistance of a human).

### VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

1-25. (canceled)

26. A server processing system for facilitating presentation of a media player interface, wherein the server processing system is configured to:
receive a request, from a viewing processing system, to view a digital moving visual work; and
enable presentation of a media player interface viewable by a viewing processing system, wherein the media player interface is configured to present the digital moving visual work via the viewing processing system, wherein the media player interface includes:
a first portion for presenting the digital moving visual work; and
a second portion for presenting a digital object associated with the rightsholder who owns a right to a portion of a digital visual work, wherein the digital object is presented by the viewing processing system when the one or more portions of the digital moving visual work associated with the party are visible during playback of the digital moving visual work.

27. The server processing system according to claim 26, wherein the server processing system transfers rights data indicative of a time period of the portion of the digital moving visual work which the rightsholder owns, wherein the viewing processing system interprets the rights data to present the digital object within the second portion of the media player interface according to the time period defined by the rights data.

28. The server processing system according to claim 26, wherein the server processing system transfers boundary data indicative of a boundary of the digital moving visual work presented within the first portion of the media player interface which is associated with the rightsholder, wherein is response to a viewing user interacting with a portion of the digital moving visual work within the boundary results in an action being performed in relation to the digital object of the rightsholder.

29. The server processing system according to claim 28, wherein the action performed includes the digital object of the rightsholder being highlighted within the second portion of the media player interface.

30. The server processing system according to claim 28, wherein the action performed includes presenting a webpage associated with the rightsholder via the viewing processing system.

31. A method for facilitating presentation of a media player, wherein the method includes:
receiving a request, from a viewing processing system, to view a digital moving visual work; and
enabling presentation of a media player interface viewable by a viewing processing system, wherein the media player interface is configured to present the digital moving visual work via the viewing processing system, wherein the media player interface includes:
a first portion for presenting the digital moving visual work; and
a second portion for presenting a digital object associated with the rightsholder who owns a right to a portion of a digital visual work, wherein the digital object is presented by the viewing processing system when the one or more portions of the digital moving visual work associated with the party are visible during playback of the digital moving visual work.

32. The method according to claim 31, wherein the method includes the server processing system transferring rights data indicative of a time period of the portion of the digital moving visual work which the rightsholder owns, wherein the viewing processing system interprets the rights data to present the digital object within the second portion of the media player interface according to the time period defined by the rights data.

33. The method according to claim 31, wherein the method includes the server processing system transferring boundary data indicative of a boundary of the digital moving visual work presented within the first portion of the media player interface which is associated with the rightsholder, wherein is response to a viewing user interacting with a portion of the digital moving visual work within the boundary results in an action being performed in relation to the digital object of the rightsholder.

34. The method according to claim 33, wherein the action performed includes the digital object of the rightsholder being highlighted within the second portion of the media player interface.

35. The method according to claim 33, wherein the action performed includes presenting a webpage associated with the rightsholder via the viewing processing system.

36. A non-transitory computer readable medium for facilitating presentation of a media player, wherein the non-transitory computer readable medium includes executable instructions which, when executed by a server processing system, configure the server processing system to:
receive a request, from a viewing processing system, to view a digital moving visual work; and
enable presentation of a media player interface viewable by a viewing processing system, wherein the media player interface is configured to present the digital moving visual work via the viewing processing system, wherein the media player interface includes:
a first portion for presenting the digital moving visual work; and
a second portion for presenting a digital object associated with the rightsholder who owns a right to a portion of a digital visual work, wherein the digital object is presented by the viewing processing system when the one or more portions of the digital moving visual work associated with the party are visible during playback of the digital moving visual work.

37. The non-transitory computer readable medium according to claim 36, wherein the server processing system is configured to transfer rights data indicative of a time period of the portion of the digital moving visual work which the rightsholder owns, wherein the viewing processing system interprets the rights data to present the digital object within the second portion of the media player interface according to the time period defined by the rights data.

38. The non-transitory computer readable medium according to claim 36, wherein the server processing system is configured to transfer boundary data indicative of a boundary of the digital moving visual work presented within the first portion of the media player interface which is associated with the rightsholder, wherein is response to a viewing user interacting with a portion of the digital moving visual work within the boundary results in an action being performed in relation to the digital object of the rightsholder.

39. The non-transitory computer readable medium according to claim 38, wherein the action performed includes the digital object of the rightsholder being highlighted within the second portion of the media player interface.

40. The non-transitory computer readable medium according to claim 38, wherein the action performed includes presenting a webpage associated with the rightsholder via the viewing processing system.

41-42. (canceled)
